(19) United States
(12) Patent Application Publication
(10) Pub. No.: US 2025/0098903 A1
(43) Pub. Date: Mar. 27, 2025

(54) MODULAR SYSTEM FOR FOOD ASSEMBLY

(71) Applicant: Hyphen Technologies, Inc., San Jose, CA (US)

(72) Inventors: Jacob Boyer, Discovery Bay, CA (US); Mayuki Sasagawa, San Jose, CA (US); Pooya Heiraty, Fremont, CA (US); Mark Marino, Oak Park, MI (US); Ethan Wilensky, San Jose, CA (US); Maneesh Jain, San Jose, CA (US); Daniel Fukuba, San Jose, CA (US); Stephen Klein, San Jose, CA (US)

(21) Appl. No.: 18/898,526

(22) Filed: Sep. 26, 2024

Related U.S. Application Data
(60) Provisional application No. 63/540,589, filed on Sep. 26, 2023.

(51) Int. Cl. A47J 44/00

(52) U.S. Cl. CPC A47J 44/00; A47J 2201/00

(57) ABSTRACT

One variation of a food preparation unit 120 includes: a manual preparation surface; an autonomous assembly zone beneath the manual preparation surface; a receptacle above the autonomous assembly zone and adjacent the manual preparation surface; a conveyor unit within the autonomous assembly zone, configured to traverse a food container through the autonomous assembly zone; and a set of actuators adjacent the receptacle and configured to, in one configuration with the dispenser receptacle occupied by a food dispensing assembly loaded with an ingredient type, selectively actuate to rotate a set of agitators in the food dispensing assembly to drive the ingredient type toward an outlet of the food dispensing assembly and to open the outlet to dispense a serving of the ingredient type toward the autonomous assembly zone.

### CROSS-REFERENCE TO RELATED APPLICATIONS

This application claims the benefit of U.S. Provisional Application No. 63/540,589, filed on 26 Sep. 2023, which is incorporated in its entirety by this reference.

### TECHNICAL FIELD

This invention relates generally to the field of food production and more specifically to a new and useful modular system for manual and autonomous food assembly in the field of food production.

### BRIEF DESCRIPTION OF THE FIGURES

FIGS. 1A and 1B are schematic representations of a modular system;

FIG. 2 is schematic representation of a variation of the modular system;

FIG. 3 is schematic representation of a variation of the modular system;

FIGS. 4A and 4B are schematic representations of a variation of the modular system;

FIGS. 5A, 5B, and 5C are schematic representations of a variation of the modular system;

FIG. 6 is schematic representation of a variation of the modular system;

FIGS. 7A and 7B are schematic representations of a variation of the modular system;

FIGS. 8A, 8B, and 8C are schematic representations of a variation of the modular system; and

FIGS. 9A, 9B, and 9C are schematic representations of a variation of the modular system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Modular System

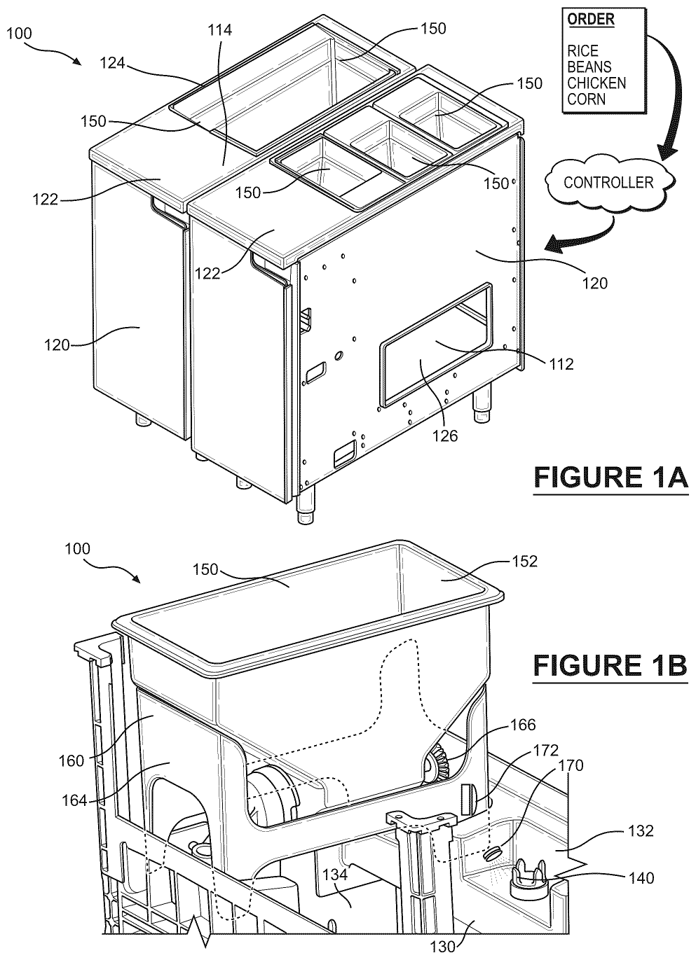

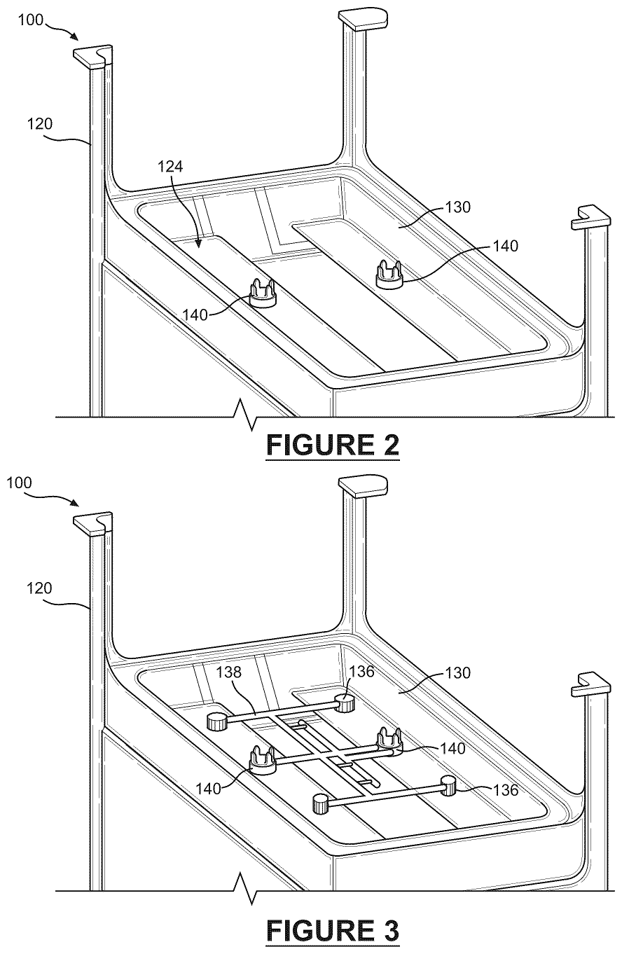

As shown in FIGS. 1A-3, a modular system includes a food preparation unit 120 configured to install in a sequence of food preparation units 120, the food preparation unit 120 including: a manual food preparation surface 122; an autonomous assembly zone 112 arranged below the manual food preparation surface 122; a dispenser receptacle 124 arranged over the autonomous assembly zone 112 and adjacent the manual food preparation surface 122; a first conveyor unit 126 arranged within the autonomous assembly zone 112 and configured to traverse a food container under the dispenser receptacle 124 and through the autonomous assembly zone 112; and a first set of actuators 140 adjacent the dispenser receptacle 124.

The first set of actuators are configured to, in a first configuration with the dispenser receptacle 124 occupied by a first food dispensing assembly 150 loaded with a first volume of a first ingredient type: actuate a first actuator 140 to rotate a first agitator 162 in the first food dispensing assembly 150 to drive the first ingredient type toward a first outlet 156 of the first food dispensing assembly 150; and actuate a second actuator 140 to open the first outlet 156 to dispense a first serving of the first ingredient type toward the autonomous assembly zone 112.

The first set of actuators are further configured to, in a second configuration with the dispenser receptacle 124 occupied by a second food dispensing assembly 150 loaded with the first volume of a second ingredient type: actuate the first actuator 140 to rotate a first set of agitators 162 in the second food dispensing assembly 150 to drive the second ingredient type toward a second set of agitators 162 in the second food dispensing assembly 150; and actuate the second actuator 140 to rotate the second set of agitators 162 to drive the second ingredient type toward a second outlet 156 of the second food dispensing assembly 150, and to open the second outlet 156 to dispense a second serving of the second ingredient type toward the autonomous assembly zone 112.

### 1.1 Variation: Kit of Food Dispensing Assemblies

As shown in FIGS. 1A, 1B, 3, and 4A-9A, one variation of the modular system 100 includes: a kit of food dispensing assemblies 150; and a food preparation unit 120, in a sequence of food preparation units.

The kit of food dispensing assemblies 150 includes: a first food dispensing assembly 150 storing a first volume of a first ingredient type; and a second set of food dispensing assemblies, each food dispensing assembly in the second set of food dispensing assemblies storing a second volume of an ingredient in a second set of ingredient types, the second volume approximately one third of the first volume.

The food preparation unit 120 includes: a manual food preparation surface 122; an autonomous assembly zone 112 arranged below the manual food preparation surface 122; a dispenser receptacle 124 arranged over the autonomous assembly zone 112 and adjacent the manual food preparation surface 122; a first conveyor unit 126 arranged within the autonomous assembly zone 112 and configured to traverse a food container under the dispenser receptacle 124 and through the autonomous assembly zone 112; and a first set of actuators 140 adjacent the dispenser receptacle 124.

The dispenser receptacle 124 is configured to: transiently receive the first food dispensing assembly 150 in a first configuration; and transiently receive the second set of food dispensing assemblies 150, in replacement of the first food dispensing assembly 150, in a second configuration.

The first set of actuators 140 are configured to: trigger release of the first ingredient type from the first food dispensing assembly 150 toward the autonomous assembly zone 112 in the first configuration; and trigger release of the second set of ingredient types from the set of food dispensing assemblies 150 toward the autonomous assembly zone 112 in the second configuration.

### 1.2 Variation: Dynamic Actuation

As shown in FIGS. 1A-3, another variation of the modular system 100 includes: a food preparation unit 120 including: a manual food preparation surface 122; an autonomous assembly zone 112 arranged below the manual food preparation surface 122; a dispenser receptacle 124 arranged over the autonomous assembly zone 112 and adjacent the manual food preparation surface 122; a conveyor unit 126 arranged within the autonomous assembly zone 112 and configured to traverse a food container under the dispenser receptacle 124 and through the autonomous assembly zone 112; and a set of actuators 140 adjacent the dispenser receptacle 124.

The set of actuators 140 are configured to, in a first configuration with the dispenser receptacle 124 occupied by a first food dispensing assembly 150 loaded with a first ingredient type: selectively actuate to rotate a first set of agitators 162 in the first food dispensing assembly 150 to drive the first ingredient type toward a first outlet 156 of the first food dispensing assembly 150 and to open the first outlet 156 to dispense a first serving of the first ingredient type toward the autonomous assembly zone 112.

The set of actuators are further configured to, in a second configuration with the dispenser receptacle 124 occupied by a second food dispensing assembly 150 loaded with a second ingredient type: selectively actuate to rotate a second set of agitators 162 in the second food dispensing assembly 150 to drive the second ingredient type toward a second outlet 156 of the second food dispensing assembly 150 and to open the second outlet 156 to dispense a second serving of the second ingredient type toward the autonomous assembly zone 112.

### 1.3 Variation: Driveshaft+Drivetrain Engagement

As shown in FIGS. 1A-4B, another variation of the modular system 100 includes: a manual food preparation surface 122; a food preparation unit 120 configured to install in a sequence of food preparation units 120, supporting the manual food preparation surface 122; a set of food dispensing assemblies 150 storing ingredients; and a controller.

The food preparation unit 120: defines a dispenser receptacle 124 configured to transiently receive a food dispensing assembly 150 in the set of food dispensing assemblies 150; defines an autonomous assembly zone 112 extending along a longitudinal assembly axis and configured to transiently house a conveyor unit 126; and includes a base platform 130 interposed between the dispenser receptacle 124 and the autonomous assembly zone 112 and including a set of actuators 140—including a first actuator 140 defining a first driveshaft 144 and a second actuator 140 defining a second driveshaft 144—arranged in a fixed arrangement. The food dispensing assembly 150 includes: an ingredient container 152 storing ingredients and defining an upper rim 153 configured to seat approximately flush with the manual food preparation surface 122; a dispenser subassembly 160 coupled to a bottom of the ingredient container 152 and configured to engage the base platform 130 to locate the food dispensing assembly 150 within the dispenser receptacle 124; and a set of agitators 162 configured to transiently couple to the dispenser subassembly 160 to seat within an interior volume of the ingredient container 152. The dispenser subassembly 160 includes: a base section 164; a first drivetrain 166—configured to mechanically couple to a first subset of agitators 162 in the set of agitators 162—integrated within the base section 164 and defining a first mount section configured to seat over and mate with the first driveshaft 144 of the first actuator 140; a second drivetrain 166—configured to mechanically couple to a second subset of agitators 162 in the set of agitators 162—integrated within the base section 164 and defining a second mount section configured to seat over and mate with the second driveshaft 144 of the second actuator 140.

The controller is configured to: selectively trigger the first actuator 140 to rotate the first driveshaft 144 in a first direction to trigger actuation of the first subset of agitators 162, and selectively trigger the second actuator 140 to rotate the second driveshaft 144 in a second direction to trigger actuation of the second subset of agitators 162, to drive ingredients stored in the interior volume toward an outlet 156 of the ingredient container 152 for dispensation toward a food container arranged in the autonomous assembly zone 112.

### 2. Applications

Generally, the modular system 100 defines a reconfigurable chassis for on-demand food production and includes: a manual food preparation surface 122 supporting manual construction of units of a food product by a worker (e.g., an employee); a food preparation unit 120 supporting the manual food preparation surface 122 and defining an autonomous assembly zone 112; a set of food dispensing assemblies 150 configured to transiently (i.e., temporarily and removably) install within the food preparation unit 120 loaded with ingredients, and configured to dispense volumes or units of these ingredients to autonomously construct units of a food product within the autonomous assembly zone 112; and a controller. The modular system 100 can be configured for installation in a food service establishment to augment manual food product assembly with autonomous food product assembly, such as to fulfill orders entered by on-site patrons and/or submitted online via remote patrons. For example, the modular system 100 can be configured to autonomously assemble generic units of the same food type within the autonomous assembly zone 112 that is concurrently assembled and customized manually by a worker at the manual food preparation surface 122. Furthermore, the modular system 100 can be assembled and reconfigured over time to produce various types of food products, such as smoothies, cold bowls (e.g., cold salads), hot bowls (e.g., hot rice bowls), cold sandwiches, hot sandwiches, cold wraps, hot wraps (e.g., burritos), desserts, coffee products, etc.

In particular, the food preparation unit 120 supports the manual food preparation surface 122 and defines: a receptacle 124 configured to receive the set of food dispensing assemblies 150 for installation within the food preparation unit 120 in an assembled configuration; and an autonomous assembly zone 112-arranged beneath the receptacle 124 and extending along a longitudinal assembly axis-housing autonomous preparation of food products. The food preparation unit 120 can define a receptacle 124 of a fixed unit dimension (e.g., width, length, height) configured to transiently receive one or more food dispensing assemblies 150 defining a standard footprint (e.g., corresponding to a standard hotel pan), such that an upper rim 153 of each food dispensing assembly 150 seats flush with the manual prep surface 122 and the dispenser subassembly 160 engages the base platform 130 of the food preparation unit 120. For example, the receptacle 124 can define a fixed cross-section approximating a standard cross-section of a standard full-sized food pan and the food dispensing assembly 150 can similarly define a cross-section configured to nest within this standard cross-section.

### 2.1 Food Preparation Unit

In one application, the food preparation unit 120 includes a base platform 130: interposed between the autonomous assembly zone 112 and the receptacle 124; housing the set of food dispensing assemblies 150; and including a set of actuators 140 arranged in a fixed configuration and configured to transiently couple to corresponding features of the food dispensing assembly 150 to drive dispensation of ingredients. The food dispensing assembly 150 includes: an ingredient container 152 (e.g., a food pan) configured to transiently store and release volumes of ingredients via a food outlet 156 (or an “outlet”); and a dispenser subassembly 160-coupled to the ingredient container 152. The dispenser subassembly 160 can include: a base section 164 coupled to a bottom of the ingredient container 152; one or more drivetrains 166 integrated into the base section 164 and defining a set of mount sections (e.g., internal splines) configured to mechanically couple to one or more actuators 140 on the base platform 130; and a set of food agitators 162 (e.g., one, two, four, six) configured to transiently install within an interior volume of the ingredient container 152 and couple to the drivetrain 166 to drive ingredients toward the food outlet 156 for dispensation responsive to actuation (e.g., in a particular direction) of the drivetrain 166 via the set of actuators 140 installed on the base platform 130.

For example, the food preparation unit 120 can include a first actuator 140 arranged on the base platform 130 and including a driveshaft 144-extending from the base platform 130 at a first location-defining an external spline section. In this example, the food dispensing assembly 150 can include a drivetrain 166-integrated within the dispenser subassembly 160 and mechanically coupled to a set of agitators 162-including an internal spline section (e.g., an internal-splined gear) configured to seat over and mate with the exterior spline section of the driveshaft 144 in the first location upon loading of the food dispensing assembly 150 into the dispenser receptacle 124. The controller can then trigger the actuator 140 to rotate the driveshaft 144 in a particular direction to actuate the drivetrain 166 and thereby actuate the set of agitators 162 to drive (e.g., push, pull) ingredients in the ingredient container 152 toward the food outlet 156. Each food dispensing assembly 150 can therefore be configured to include the set of mount sections in one or more target positions within the base section 164 of the dispenser subassembly 160, such that these target positions align with the fixed arrangement of actuators on the base platform 130 in the assembled configuration.

By including the set of actuators 140 rigidly installed within the food preparation unit 120-rather than within the food dispensing assembly 150—the modular system 100 can reduce a quantity of moving parts integrated within the food dispensing assembly 150, thereby reducing complexity and increasing a shelf life of the food dispensing assembly 150. In particular, by reducing complexity of the food dispensing assembly 150, the modular system 100 can enable regular loading of the food dispensing assembly 150 with varying ingredients (e.g., wet and/or dry ingredients), installation and/or removal of the food dispensing assembly 150 from the food preparation unit 120, and/or regular cleaning of the food dispensing assembly 150 (e.g., to remove food residue), without risk of damage to the set of actuators 140 and/or other moving parts.

### 2.2 Suite of Actuators+Dynamic Actuation

The modular system 100 can include a sequence of interchangeable base platforms 130 configured to transiently install within the receptacle 124. In particular, the sequence of interchangeable base platforms 130 can include various configurations of actuators 140 configured to selectively trigger release of ingredients from various food dispensing assemblies 150.

In one example, the food preparation unit 120 can transiently receive a first base platform 130, and a second base platform 130 in replacement of the first base platform 130. In this example, in a first configuration (e.g., during a weekday lunch period), the food preparation unit 120 can: receive the first base platform 130 including a set of two actuators 140; and receive a full-sized food dispensing assembly 150 configured to seat over and mechanically couple to the set of two actuators 140 and loaded with lettuce. In the first configuration, the food preparation unit 120 can selectively actuate the first and second actuators to rotate a set of agitator arms in the first food dispensing assembly 150 to dispense lettuce into a food container located in the autonomous assembly zone 112.

Additionally, in this example, in a second configuration (e.g., during a weekday dinner period): the food preparation unit 120 can: receive the second base platform 130 including a set of six actuators 140; and receive a set of three third-sized food dispensing assemblies 150 each configured to seat over and mechanically couple to a subset of two actuators 140. More specifically, in the second configuration, based on a particular food order, the food preparation unit 120 can receive: a first third-sized food dispensing assembly 150 loaded with brown rice; a second third-sized food dispensing assembly 150 loaded with white rice; and a third third-sized food dispensing assembly 150 loaded with fried rice.

In the second configuration, the food preparation unit 120 can: selectively actuate a first actuator and a second actuator to rotate a first set of agitators and open a first outlet of the first third-sized food dispensing assembly 150 to dispense brown rice into a food container located in the autonomous assembly zone 112; selectively actuate a third actuator and a fourth actuator to rotate a second set of agitators and open a second outlet of the second third-sized food dispensing assembly 150 to dispense white rice into a food container located in the autonomous assembly zone 112; and/or selectively actuate a fifth actuator and a sixth actuator to rotate a third set of agitators and open a third outlet of the third, third-sized food dispensing assembly 150 to dispense fried rice into a food container located in the autonomous assembly zone 112.

### 2.3 Food Dispensing Assemblies

Furthermore, the modular system 100 can include various food dispensing assemblies 150 configured to store and dispense ingredients of varying types (e.g., solid, liquid, high or low viscosity, moisture level) and/or varying amounts. For example, each food dispensing assembly 150 can define: a particular geometry and/or footprint configured to nest within the dispenser receptacle 124 between the manual prep surface 122 and the base platform 130; a particular outlet 156 type matched to a particular ingredient type(s) and/or a target plating pattern (e.g., layered, radial, oval, round, and/or rectangular plating); and/or a particular type(s) of food agitator 162 compatible with the dispenser type and/or ingredient type, such as defining a particular size and/or geometry. Therefore, in order to enable dispensation of ingredients from each food dispensing assembly 150, in the set of food dispensing assemblies 150, each food dispensing assembly 150 of each dispenser type can be configured to include one or more mount sections arranged in a particular location (e.g., within the dispenser subassembly 160), such that the mount section aligns with a driveshaft 144 of a corresponding actuator arranged on the base platform 130. An operator may therefore install, remove, and/or replace food dispensing assemblies 150 of various dispenser types within the dispenser receptacle 124 over time in order to accommodate dispensation of different ingredients and/or rearrange a distribution ingredients, regardless of variation between dispenser types.

### 2.4 Sequence of Food Preparation Units

The modular system 100 can include a sequence of food preparation units 120, each configured to transiently house various combinations of one or more food dispensing assemblies 150 to enable reconfiguration of a particular assembly line. In particular, the modular system 100 can include any quantity of food preparation units 120 arranged in a particular order to enable storage and dispensation of each ingredient required for preparation of units of the food product. Furthermore, each food preparation unit 120 can be configured to transiently house a kit of food dispensing assemblies 150 (i.e., a set of different-sized food dispensing assemblies 150) configured to store different volumes of different ingredient types.

In one example, the modular system 100 can include a first food preparation unit 120 and a second food preparation unit 120 arranged adjacent the first food preparation unit 120. In this example, in a first configuration (e.g., during a weekday lunch period): the first food preparation unit 120 can house a full-sized food dispensing assembly 150 configured to dispense chicken; and the second food preparation unit 120 can house a set of two half-sized food dispensing assemblies 150 including a first half-sized food dispensing assembly 150 configured to dispense black beans, and a second half-sized food dispensing assembly 150 configured to dispense white rice.

Additionally, in this example, in a second configuration (e.g., during a weekday dinner period): the first food preparation unit 120 can house the set of two half-sized food dispensing assemblies 150 including the first half-sized food dispensing assembly 150 configured to dispense black beans, and the second half-sized food dispensing assembly 150 configured to dispense lettuce; and the second food preparation unit 120 can house a set of three third-sized food dispensing assemblies 150 including first, second, and third third-sized food dispensing assemblies 150 configured to dispense guacamole, corn, and steak, respectively.

Accordingly, the modular system 100 can be reconfigured over time to accommodate changing assembly line requirements (e.g., due to seasonal menu changes), such as by: reconfiguring the kit of food dispensing assemblies 150 within the dispenser receptacle to arrange each ingredient type in a target position (e.g., moving a food dispensing assembly 150 configured to dispense rice from a first position to a second position of the food preparation unit 120 and installing another food dispensing assembly 150 configured to dispense beans in the first position); and/or replacing the base platform 130 to accommodate the actuation requirements for different sets of food dispensing assemblies 150 (e.g., replacing a base platform 130 with two actuators 140 with another base platform 130 with six actuators 140 to accommodate six, sixth-size food dispensing assemblies 150).

Thus, upon installation of the modular system 100 within a food service establishment, the modular system 100 can be easily reconfigured (e.g., throughout the life-cycle of the instance of the modular system 100) to adapt the assembly line for evolving food products. More specifically, rather than uninstalling a chassis that houses the sequence of food preparation units 120 and reordering the food preparation units 120 based on fixed size and/or actuation capabilities, the modular system 100 can be rapidly reconfigured via rearrangement of the interchangeable food dispensing assemblies 150 and/or the interchangeable base platforms 130 to produce various types of food products.

### 3. Food Production Station

Generally, components of the modular system 100 can be assembled to form a food production station 100. The modular system 100 can be configured to install within a food service establishment (e.g., a “fast-casual” restaurant, a ghost kitchen, a food court, a cafeteria) and can be assembled and reconfigured over time to produce various types of food product, such as smoothies, cold bowls (e.g., cold salads), hot bowls (e.g., hot rice bowls), cold sandwiches, hot sandwiches, cold wraps, hot wraps (e.g., burritos), pizzas, desserts, coffee products, etc.

The modular system 100 defines a housing (or “chassis”) configured to locate a combination of food dispensing assemblies 150 for fulfillment of food orders. In one implementation, the modular system 100 includes: a chassis (e.g., a rigid platform) defining a manual food preparation surface 122 (hereinafter a “prep surface”); and a sequence of food preparation units 120 (e.g., one or more food preparation units 120 arranged contiguously) arranged beneath the manual prep surface 122 and configured to house a sequence of food dispensing assemblies 150 configured to store and/or dispense ingredients for fulfillment of food orders. For example, the modular system 100 can include: a steel box frame configured to locate a sequence of food dispensing assemblies 150; a manual prep surface 122 (e.g., a stainless steel surface) arranged over a top face of the steel box frame; and a set of legs (e.g., a set of round tubular legs) coupled to a bottom face opposite the top face of the steel box frame and configured to house the steel box frame.

The modular system 100 can define a particular height (e.g., a work height) such that an employee may comfortably stand facing a front side of the modular system 100 while handling food (e.g., adding ingredients to a serving container, preparing ingredients, refilling food hopper) on the manual prep surface 122 and/or interfacing with a patron. For example, the modular system 100 can exhibit a height-between a ground surface and the manual prep surface 122-approximately (e.g., within two inches) between 35 inches and 42 inches. Furthermore, the bottom face of the modular system 100 can be offset a ground surface (e.g., the floor) in order to enable cleaning beneath the modular system 100.

For example, the modular system 100 can include the set of legs defining a particular height such that: an employee may clean the bottom face of the modular system 100 and surfaces (e.g., the floor) below the modular system 100; the manual prep surface 122 sits within a working height range (e.g., between 36 and 38 inches); and the food preparation unit 120 fits between the bottom face and the manual prep surface 122.

In one implementation, the modular system 100 defines: a manual assembly zone 114-including the manual prep surface 122-housing manual preparation of food products; and an autonomous assembly zone 112-arranged below the manual assembly zone 114 and extending along a longitudinal assembly axis defined by the sequence of food preparation units 120-housing autonomous preparation of food products.

In particular, in this implementation, the modular system 100 can include: a sequence of food preparation units defining an autonomous assembly zone 112 extending along a longitudinal assembly axis and configured to transiently house a set of food dispensing assemblies 150 configured to store ingredients for manual and autonomous preparation of food products; a set of conveyor units 126 configured to move a food container along a length of the autonomous assembly zone 112 as the food container is filled with ingredients dispensed by the set of food dispensing assemblies 150; and a controller configured to receive food orders from patrons and selectively actuate the set of food dispensing assemblies 150 for dispensation of ingredients toward the autonomous assembly zone 112 in order to complete these food orders.

### 4. Food Preparation Unit

The modular system 100 includes a sequence of food preparation units 120 supporting the manual prep surface 122 and extending along a longitudinal assembly axis. Each food preparation unit 120, in the sequence of food preparation units 120, can be configured to transiently house a set of food dispensing assemblies 150 (e.g., one or more food dispensing assemblies 150) configured to store and dispense amounts of ingredients for autonomous preparation of units of a food product. The sequence of food preparation units 120 can therefore be arranged in a particular order and/or include a particular quantity of food preparation units 120 to enable storage and dispensation of each ingredient required for preparation of units of the food product.

In one implementation, the modular system 100 includes a sequence of food preparation units 120, each food preparation unit 120: supporting and/or extending below the manual prep surface 122; defining an autonomous assembly zone 112 extending along a longitudinal assembly axis; and configured to transiently house a set of food dispensing assemblies 150 configured to dispense ingredients-contained and/or stored in the set of food dispensing assemblies 150—toward the autonomous assembly zone 112.

The food preparation unit 120 can include: a base platform 130 arranged above the autonomous assembly zone 112—and below the manual prep surface 122—approximately parallel the longitudinal assembly axis and defining a center bore 134; a dispenser receptacle 124 configured to transiently receive a food dispensing assembly 150—from above the manual prep surface 122—to seat the food dispensing assembly 150 on an upper surface of the base platform 130 and align an outlet 156 of the food dispensing assembly 150 with the center bore 134; and a conveyor unit 126 transiently installed below the base platform 130—within the autonomous assembly zone 112—and configured to locate a food container (e.g., a bowl or plate) below the center bore 134 for dispensation of ingredients from the food dispensing assembly 150 (e.g., via the outlet 156) into the food container.

The food preparation unit 120 can further include a set of actuators 140 coupled to an upper surface of the base platform 130 and configured to transiently engage a set of drivetrains 166 integrated into a base of the food dispensing assembly 150. The controller can thus regulate dispensation of ingredients from the food dispensing assembly 150 by selectively driving the set of actuators 140 mechanically coupled to the set of drivetrains 166 of the food dispensing assembly 150.

Furthermore, the set of actuators 140 can be arranged in a particular configuration across the upper surface of the base platform 130, such that—when coupled to the set of drivetrains 166 integrated into the food dispensing assembly 150—the outlet 156 of the food dispensing assembly 150 seats directly above and/or within the center bore 134 and the upper rim 153 of the food dispensing assembly 150 seats approximately flush with the manual prep surface 122 (e.g., within +0.5 inch). A user may therefore drop the food dispensing assembly 150 into the receptacle 124 of the first food preparation unit 120 (e.g., from above the manual prep surface 122)—such as in a target orientation—to engage the set of drivetrains 166 with the set of actuators 140 arranged on the base platform 130 and therefore seat the upper rim 153 of the food dispensing assembly 150 approximately flush with the manual prep surface 122 and seat the outlet 156 of the food dispensing assembly 150 over and/or within the center bore 134.

The modular system 100 can include a set of sensors (e.g., an optical sensor, a load sensor) installed (e.g., permanently or semi-permanently installed) within each food preparation unit 120 in the sequence of food preparation units 120. In particular, a food preparation unit 120 can include a set of sensors coupled to various components of the food preparation unit 120—such as walls of the food preparation unit 120, the base platform 130, the conveyor unit 126, etc.—configured to output various signals such as representing amounts of ingredients remaining in a food dispensing assembly 150, amounts of ingredients dispensed into a food container on the conveyor unit 126, a position of a food container relative the food dispensing assembly 150, etc.

### 4.1 Dispenser Receptacle

The food preparation unit 120 defines a dispenser receptacle 124 (hereinafter a “receptacle 124”) configured to transiently receive a set of food dispensing assemblies 150 storing ingredients for manual preparation of food products on the manual prep surface 122 and autonomous preparation of food products within the food preparation unit 120. In particular, the receptacle 124 can be configured to locate the food dispensing assembly 150 within the food preparation unit 120, such that a base of the food dispensing assembly 150 engages the upper surface of the base platform 130 and an upper rim 153 of the ingredient container 152-loaded with and/or configured to be loaded with ingredients—seats approximately flush with the manual prep surface 122.

In one implementation, the food preparation unit 120 defines a receptacle 124 of a fixed unit dimension (e.g., width, length, height) and configured to transiently receive one or more food dispensing assemblies 150 defining a standard footprint. In particular, in this implementation, the receptacle 124 can be loaded with one or more food dispensing assemblies 150 forming an assemblage of food dispensing assemblies 150 that cooperate to define a standard footprint. For example, the receptacle 124 can define a fixed longitudinal cross-section (e.g., parallel the manual prep surface 122) approximating a standard cross-section of an industry-standard, full-size food pan, such as defining a standard length of approximately 21.75 inches (e.g., within five percent) and a standard width of approximately 12.75 inches (e.g., within five percent). In this example, the receptacle 124 can therefore be configured to receive: a single food dispensing assembly 150 (hereinafter a “full-size food dispensing assembly 150”) defining the standard cross-section of the full-size food pan; a set of two food dispensing assemblies 150 (hereinafter a “half-size food dispensing assembly 150”), each defining a cross-section of approximately one-half of the standard cross-section; a set of three food dispensing assemblies 150 (hereinafter a “third-size food dispensing assembly 150”), each defining a cross-section of approximately one-third of the standard cross-section; and/or a set of six food dispensing assemblies 150 (hereinafter a “sixth-size food dispensing assembly 150”), each defining a cross-section of approximately one-sixth of the standard cross-section; etc.

Furthermore, the receptacle 124 can be configured to receive a kit of food dispensing assemblies 150 including combinations of food dispensing assemblies 150 of varying sizes, such as: a set of four food dispensing assemblies 150 including a first third-size food dispensing assembly 150, a second third-size food dispensing assembly 150, a first sixth-size food dispensing assembly 150, and a second sixth-size food dispensing assembly 150; a set of five food dispensing assemblies 150 including a half-size food dispensing assembly 150, a first sixth-size food dispensing assembly 150, a second sixth-size food dispensing assembly 150, a third sixth-size food dispensing assembly 150, and a fourth sixth-size food dispensing assembly 150; etc.

### 4.2 Base Platform: Fixed Arrangement of Actuators

Each food preparation unit 120 can include a base platform 130 arranged below and offset the manual prep surface 122 by a first target height approximating a height of a food dispensing assembly 150. Furthermore, the base platform 130 can be arranged above and offset the bottom surface of the food preparation unit 120 in order to accommodate the conveyor unit 126 and autonomous assembly of food products within the autonomous assembly zone 112 extending along the longitudinal assembly axis.

In one implementation, the base platform 130: defines a center bore 134 defining a central axis approximately perpendicular the longitudinal assembly axis of the autonomous assembly zone 112; defines an upper surface facing the receptacle 124 above the base platform 130; and includes a set of actuators 140 arranged in a fixed arrangement across the upper surface. The set of actuators 140 can be configured to transiently engage a set of drivetrains 166 of a food dispensing assembly 150 to: constrain the food dispensing assembly 150 within the receptacle 124 and retain the base section 164 of the food dispensing assembly 150 against the upper surface of the base platform 130; align an outlet 156 of the food dispensing assembly 150 with the center bore 134 of the base platform 130 arranged over the autonomous assembly zone 112; and transiently drive dispensation of ingredients from the outlet 156 of the food dispensing assembly 150 toward the autonomous assembly zone 112 via actuation of the set of drivetrains 166.

In this implementation, each actuator 140, in the set of actuators 140, can define a driveshaft 144 extending vertically upward-such as toward the receptacle 124 and/or manual prep surface 122—from the upper surface of the base platform 130 and configured to transiently insert into a receiving section (e.g., a splined bore) of a drivetrain 166 integrated into the base section 164 of the food dispensing assembly 150 to mechanically couple to the drivetrain 166. In particular, walls of the base platform 130-extending from the upper surface toward the manual prep surface 122—can be configured to transiently engage the base section 164 of the dispenser to align the receiving section with the driveshaft 144 extending from the upper surface. These walls of the base platform 130 and the base section 164 of the dispenser can thus cooperate to locate and/or constrain the receiving section along a target axis-defined by the driveshaft 144—and/or within a threshold distance of the target axis, thereby enabling the receiving section to rigidly mate with the driveshaft 144.

In one example implementation, the base platform 130 defines a first dispenser seat section 132—arranged proximal a rear of the food preparation unit 120 and spanning a width of the receptacle 124—including: a first actuator 140—defining a first driveshaft 144 extending upward from the upper surface and into the receptacle 124—arranged on a first side of the center bore 134; and a second actuator 140—defining a second driveshaft 144 extending upward from the upper surface and into the receptacle 124—arranged on a second side of the center bore 134 opposite the first side. In this example implementation, the receptacle 124 can be configured to: receive and locate a first food dispensing assembly 150 loaded with a first volume of a first ingredient-spanning the first dispenser seat section 132—and configured to engage both the first and second actuators 140 on the first dispenser seat section 132 in a first configuration.

### 4.2.1 Actuation Based on Installed Food Dispensing Assembly

Each set of actuators 140 can be configured to trigger release of ingredients from various food dispensing assemblies 150 toward the autonomous assembly zone 112 via actuation of the set of drivetrains 166. For example, the set of actuators 140 can selectively actuate to rotate agitators 162 and/or open an outlet 156 of the different food dispensing assemblies 150.

In one example, the set of actuators 140 includes a first actuator 140 and a second actuator 140 adjacent the receptacle 124 and configured to, in a first configuration with the dispenser receptacle 124 occupied by a first food dispensing assembly 150 loaded with a first volume of chicken: actuate the first actuator 140 to rotate a first agitator 162 in the first food dispensing assembly 150 to drive the chicken toward a first outlet 156 of the first food dispensing assembly 150; and actuate the second actuator 140 to open the first outlet 156 to dispense a serving of chicken toward the autonomous assembly zone 112.

In this example, the set of actuators 140 is further configured to, in a second configuration with the dispenser receptacle 124 occupied by a second food dispensing assembly 150 loaded with the first volume of black beans: actuate the first actuator 140 to rotate a set of horizontal agitators 162 in the second food dispensing assembly 150 to drive the black beans toward a set of vertical agitators 162 in the second food dispensing assembly 150; and actuate the second actuator 140 to rotate the second set of agitators 162 to drive the black beans toward a second outlet 156 of the second food dispensing assembly 150 and to open the second outlet 156 to dispense a serving of black beans toward the autonomous assembly zone 112.

In this example, the first actuator can selectively actuate: to rotate a set of agitators in the first configuration; and to rotate a set of agitators and to open an outlet in the second configuration. Therefore, the set of actuators 140 can selectively actuate in different configurations to accommodate a variety of food dispensing assemblies 150, thereby eliminating the need to replace the base platform 130 (i.e., the set of actuators 140) for each reconfiguration of the modular system 100.

### 4.2.2 Variation: Dynamic Actuation

In one variation, the modular system 100 can include a gearbox 138 configured to mechanically couple to a set of couplers 136 of the food dispensing assemblies 150 to trigger release of ingredients from various food dispensing assemblies 150 toward the autonomous assembly zone 112 via actuation of the set of drivetrains 166, as shown in FIG. 3. In particular, rather than the base platform 130 including a set of actuators 140, wherein each actuator is independently actuated, the base platform 130 can include: a set of couplers 136 arranged on the base platform 130 and configured to locate a set of food dispensing assemblies 150; a first actuator 140 configured to mechanically couple to the set of couplers 136 to trigger release of the ingredient types stored in the set of food dispensing assemblies 150; and a second actuator 140 configured to selectively couple the first actuator 140 to one of the food dispensing assemblies 150 in the set of food dispensing assemblies 150 to selectively trigger release of the ingredient types stored in the set of food dispensing assemblies 150.

In one example implementation, the base platform 130 can include: a gearbox 138 configured to mechanically couple to the set of couplers 136 configured to locate a set of food dispensing assemblies 150 including a first, second, and third food dispensing assembly 150 (e.g., a set of three third-size food dispensing assemblies 150) and coupled to a set of drivetrains 166 of the first, second, and third food dispensing assemblies 150; the first actuator 140 configured to drive the gearbox 138 to rotate the set of couplers 136 to selectively trigger release of ingredients from the first, second, and third food dispensing assemblies 150 toward the autonomous assembly zone 112; and the second actuator 140 configured to selectively couple the first actuator 140 to one of the first, second, and third food dispensing assemblies 150 via the gearbox 138. Therefore, the modular system 100 can be configured to efficiently control the release of ingredients from multiple food dispensing assemblies 150 via a centralized gearbox 138, thereby eliminating the need for individual motors for each actuator 140.

### 4.2.3 Interchangeable Base Platform

Each base platform 130 can be configured to transiently install within the food preparation unit 120, such that each food production unit 120 can be reconfigured to accommodate a variety of food dispensing assembly 150 configurations, as shown in FIGS. 1B, 2, and 3.

In one example implementation, in a first configuration, the food production unit 120 includes a first base platform 130: configured to transiently locate within the dispenser receptacle 124; and defining a dispenser seat section 132 spanning a width and a length of the receptacle 124 and configured to locate a food dispensing assembly 150 within the dispenser receptacle 124. In this example implementation, the dispenser seat section 132 includes a first actuator 140-defining a first driveshaft 144 extending upward from the upper surface and into the receptacle 124; and a second actuator 140-defining a second driveshaft 144 extending upward from the upper surface and into the receptacle 124. In this example implementation, the receptacle 124 can be configured to: receive and locate a food dispensing assembly 150 loaded with a first volume of an ingredient type-spanning the dispenser seat section 132—and configured to engage both the first and second actuators 140 on the first dispenser seat section 132.

In this example implementation, in the first configuration, the first base platform 130 includes a first set of actuators 140 adjacent the dispenser receptacle 124 and configured to selectively actuate to drive and/or dispense ingredients from the food dispensing assembly 150 toward the autonomous assembly zone 112. In particular, the first set of actuators 140 includes: the first actuator 140 configured to mechanically couple to a first drivetrain 166 of the food dispensing assembly 150 to rotate a set of agitators 162 in the food dispensing assembly 150 to drive ingredients toward an outlet 156 of the food dispensing assembly 150; and the second actuator 140 configured to mechanically couple to a second drivetrain 166 of the food dispensing assembly 150 to open the outlet 156 to dispense a serving of ingredients toward the autonomous assembly zone 112 (e.g., toward a food container).

Additionally or alternatively, in this example implementation, in a second configuration, the food production unit 120 includes a second base platform 130: configured to transiently locate within the dispenser receptacle 124 in replacement of the first base platform 130; and defining a set of dispenser seat sections 132 configured to locate a set of food dispensing assemblies 150 within the dispenser receptacle 124. In particular, the second base platform 130 defines: a first dispenser seat section 132 configured to locate a first food dispensing assembly 150 storing a first volume of a first ingredient type (e.g., corn, chicken, beans), within the dispenser receptacle 124 and adjacent the manual food preparation surface 122, the second volume approximately one third of the first volume; a second dispenser seat section 132 configured to locate a second food dispensing assembly 150 storing the first volume of a second ingredient type (e.g., leafy greens), within the dispenser receptacle 124 and adjacent the first food dispensing assembly 150 opposite the manual food preparation surface 122; and a third dispenser seat section 132 configured to locate a third food dispensing assembly 150 storing the second volume of a third ingredient type (e.g., guacamole), within the dispenser receptacle 124 and adjacent the second food dispensing assembly 150 opposite the first food dispensing assembly 150.

In this example implementation, in the second configuration, the second base platform 130 includes a second set of actuators 140 adjacent the dispenser receptacle 124 and configured to selectively actuate to drive and/or dispense ingredients from the set of food dispensing assemblies 150 toward the autonomous assembly zone 112. In particular, the second base platform 130 can include: the first dispenser seat section 132 including a first actuator 140 arranged on the first side of the receptacle 124 and a second actuator 140 arranged on the second side of the receptacle 124; the second dispenser seat section 132 including a third actuator 140 arranged on the first side of the receptacle 124 and a fourth actuator 140 arranged on the second side of the receptacle 124; and the third dispenser seat section 132 including a fifth actuator 140 arranged on the first side of the receptacle 124 and a sixth actuator 140 arranged on the second side of the receptacle 124.

In the second configuration, the receptacle 124 can be configured to: receive and locate the set of food dispensing assemblies 150-spanning the first, second, and third dispenser seat sections 132—each food dispensing assembly 150 configured to engage both the first and second actuators 140 on the respective dispenser seat section 132.

In particular, the second base platform 130 can receive: the first food dispensing assembly 150—configured to engage the first and second actuators 140—within the first dispenser seat section 132; the second food dispensing assembly 150—engaging the third and fourth actuators 140-within the second dispenser seat section 132; and the third food dispensing assembly 150-engaging the fifth and sixth actuators 140-within the third dispenser seat section 132. In particular, each of the first dispenser seat section 132, the second dispenser seat section 132, and the third dispenser seat section 132 includes: an actuator 140 configured to mechanically couple to a first drivetrain 166 of the food dispensing assembly 150 to rotate a set of agitators 162 in the food dispensing assembly 150 to drive ingredients toward an outlet 156 (e.g., to drive ingredients horizontally) of the food dispensing assembly 150; and an actuator configured to mechanically couple to a second drivetrain 166 of the food dispensing assembly 150 to further drive ingredients toward the outlet 156 (e.g., to drive ingredients vertically) of the food dispensing assembly 150 and/or to open the outlet 156 to dispense a serving of ingredients toward the autonomous assembly zone 112 (e.g., toward a food container). Thus, in the second configuration, the second base platform 130 can selectively actuate the second set of actuators 140 to dispense ingredients from each of the first, second, and third food dispensing assemblies 150 occupying the food preparation unit 120.

Additionally or alternatively, in a third configuration, the food production unit 120 includes the second base platform 130 defining the first, second, and third dispenser seat sections 132. In the third configuration, the second base platform 130 can receive: a first food dispensing assembly 150—configured to engage the first actuator 140—within a first side of the first dispenser seat section 132; a second food dispensing assembly 150—configured to engage the second actuator 140—within a second side of the first dispenser seat section 132; a third food dispensing assembly 150—configured to engage the third actuator—within the first side of the second dispenser seat section 132; a fourth food dispensing assembly 150—configured to engage the fourth actuator 140—within the second side of the second dispenser seat section 132; and/or a third food dispensing assembly 150-engaging the fifth and sixth actuators 140—within the third dispenser seat section 132.

Thus, in the third configuration, the receptacle 124 can be configured to: receive and locate a set of two food dispensing assemblies 150 spanning the first dispenser seat section 132 in combination, such that a first food dispensing assembly 150, in the set of two food dispensing assemblies 150, engages the first actuator 140 and a second food dispensing assembly 150, in the set of two food dispensing assemblies 150, engages the second actuator 140.

Accordingly, the base platform 130 can be reconfigured within a particular food preparation unit 120 to accommodate various actuation requirements of the kit of food dispensing assemblies 150. Furthermore, the food dispensing assemblies 150 can be reconfigured within a particular food preparation unit 120 to further configure the ingredient locations for a particular assembly line. Therefore, the modular system 100 can be reconfigured over time to produce various types of food products, without the need to disassemble and rearrange the sequence of food preparation units 120.

### 4.3 Sequence of Food Preparation Units

The modular system 100 can include a sequence of food preparation units 120, wherein each food preparation unit 120 can be configured to transiently house the set of food dispensing assemblies 150 configured to store and dispense amounts of ingredients for autonomous preparation of units of a food product, as shown in FIG. 1A. In particular, the modular system 100 can include a particular quantity of food preparation units 120 arranged in a particular order to enable storage and dispensation of each ingredient required for preparation of units of the food product.

In one example implementation, the modular system 100 can include a first food preparation unit 120, and a second food preparation unit 120 arranged adjacent the first food preparation unit 120. In this example implementation, the first food preparation unit 120 can include: a first manual food preparation surface 122; a first autonomous assembly zone 112; a first dispenser receptacle 124 occupied by a first food dispensing assembly 150 loaded with chicken; a first conveyor unit 126 arranged within the first autonomous assembly zone 112 and configured to traverse a food container under the first dispenser receptacle 124 and through the first autonomous assembly zone 112; and a first set of actuators 140 adjacent the dispenser receptacle 124 and configured to selectively actuate to drive and/or dispense volumes of chicken toward the first autonomous assembly zone 112 (i.e., into a food container arranged in the autonomous assembly zone 112).

Furthermore, in this example implementation, the second food preparation unit 120 can include: a second manual prep surface 122 arranged adjacent the first manual prep surface 122; a second autonomous assembly zone 112 arranged below the second manual food preparation surface 122; a second dispenser receptacle 124-arranged over the second autonomous assembly zone 112 and adjacent the second manual food preparation surface 122-occupied by a second food dispensing assembly 150 loaded with white rice; a second conveyor unit 126 arranged within the second autonomous assembly zone 112 and configured to traverse the food container under the second dispenser receptacle 124 and through the second autonomous assembly zone 112 (e.g., in conjunction with the first conveyor unit 126); and a second set of actuators 140 adjacent the second dispenser receptacle 124 and configured to selectively actuate to drive and/or dispense volumes of white rice toward the second autonomous assembly zone 112.

Accordingly, in this example implementation, the modular system 100 can define: a manual assembly zone 114 encompassing the first and second manual prep surfaces 122; and an autonomous assembly zone 112 encompassing the first and second autonomous assembly zones 112. Therefore, the modular system 100 can be scaled to include any quantity of food preparation units 120, thereby enabling the modular system 100 to adapt to the specific requirements of various food service establishments and assembly line configurations.

### 5. Food Dispensing Assembly

The modular system 100 can include a set of food dispensing assemblies 150 150 configured to store and/or dispense ingredients for both manual preparation of food products within the manual assembly zone 114 and autonomous preparation of food products within the autonomous assembly zone 112. Each food dispensing assembly 150, in the set of food dispensing assemblies 150, can be configured to transiently install within a receptacle 124 of any food preparation unit 120, in the sequence of food preparation units 120, for dispensation of ingredients into food containers passed along the autonomous assembly zone 112 via the conveyor unit 126.

In one implementation, a food dispensing assembly 150 includes: an ingredient container 152 configured to store ingredients for manual and autonomous preparation of food products; and a dispenser subassembly 160—coupled to the ingredient container 152—and configured to couple to one or more food agitators 162 (e.g., a mixer, an auger) extending into an interior volume of the ingredient container 152 and configured to drive ingredients toward an outlet 156 of the ingredient container 152 in the assembled configuration. In this implementation, the ingredient container 152 defines: an upper rim 153 configured to seat approximately flush with the manual prep surface 122 in the assembled configuration; a bottom face opposite the upper rim 153; and an outlet 156 (e.g., an opening) configured to release volumes of ingredients (e.g., via gravity) from an interior volume of the ingredient container 152 toward the autonomous assembly zone 112. The dispenser subassembly 160 includes: a base section 164 (e.g., a chassis) coupled to the bottom face and/or side walls of the ingredient container 152; a drivetrain 166 (e.g., a gearbox 138) integrated within the base section 164 and configured to transiently couple to the set of actuators 140 arranged on the base platform 130 of the food preparation unit 120; and a set of agitators 162 (e.g., augers, agitator arms)-transiently coupled to the drivetrain 166 (and therefore mechanically couple to the set of actuators 140) and extending into the interior volume of the ingredient container 152-configured to drive (e.g., push or draw) ingredients loaded in the ingredient container 152 toward the outlet 156 responsive to actuation via the set of actuators 140 and the drivetrain 166. In particular, in the assembled configuration—in which the drivetrain 166 is coupled to the set of actuators 140—the set of actuators 140 can be configured to apply a torque on the drivetrain 166 to drive rotation and/or oscillation of the set of agitators 162 and thus drive (e.g., push or draw) ingredients in the ingredient container 152 toward the outlet 156.

In this implementation, the modular system 100 can include food dispensing assemblies 150 of a set of dispenser types, such as configured to store and dispense different volumes and/or types of ingredients. Each food dispensing assembly 150—of each dispenser type—can therefore be configured: to transiently seat within the receptacle 124—within a vertical range spanning between the manual prep surface 122 and the base platform 130; to couple to one or more actuators 140 arranged on the base platform 130; store varying amounts (e.g., volumes) of ingredients; and to store and release different types of ingredients.

### 5.1 Ingredient Container

The ingredient container 152 (e.g., a food pan) is configured to transiently store ingredients within an interior volume of the ingredient container 152. Generally, the ingredient container 152 defines: an upper rim 153 configured to seat approximately flush with the manual prep surface 122 in the assembled configuration; and an outlet 156 (e.g., an opening) configured to transiently release volumes of ingredients (e.g., via gravity) from an interior volume of the ingredient container 152 toward the autonomous assembly zone 112.

The ingredient container 152 can define a container outlet 156 configured to transiently release volumes of ingredients from an interior volume of the ingredient container 152 responsive to actuation of the set of agitators 162 of the dispenser subassembly 160. In one implementation, the ingredient container 152 can include a container outlet 156 defining a particular outlet type, in a set of outlet types, corresponding to a type of ingredient loaded in the food dispensing assembly 150. For example, the ingredient container 152 can define: a chute fluidly coupled to an upper region of the ingredient container 152 and configured to direct ingredients of a first type—such as including chicken, rice, beans, etc.—collected from the upper region toward the center bore 134; and/or an opening arranged in the bottom surface 155 of the ingredient container 152 and configured to dispense liquid ingredients. In one implementation, the outlet 156 can be arranged in a particular location corresponding to a size of the food dispensing assembly 150, such that a release point of the outlet 156 seats above and/or within the center bore 134 of the base platform 130, thereby enabling flow of ingredients through the center bore 134 and toward a food container arranged on the conveyor unit 126 within the autonomous assembly zone 112.

### 5.2 Dispenser Subassembly

The dispenser subassembly 160 transiently couples to the ingredient container 152 and includes: a base section 164—rigidly and/or transiently mounted to the bottom face of the ingredient container 152—configured to locate the ingredient container 152 and transiently engage the upper surface of the base platform 130 of the food preparation unit 120; a drivetrain 166—integrated into the base section 164—and configured to mechanically couple to the set of actuators 140 on the base platform 130 of the food preparation unit 120; and a set of agitators 162 transiently coupled to the drivetrain 166 and extending across the interior volume of the ingredient container 152. In particular, the drivetrain 166 can be configured to transiently couple to the set of actuators 140 in the assembled configuration and transfer a torque applied by the set of actuators 140 to the set of agitators 162 and drive rotation and/or oscillation of the set of agitators 162 within the interior volume of the ingredient container 152. Furthermore, each agitator 162, in the set of agitators 162, can be configured to couple to the drivetrain 166 in a particular orientation (e.g., within the interior volume), such that actuation (e.g., rotation, oscillation) of the agitator 162—via the set of actuators 140 and the drivetrain 166—drives ingredients within the interior volume of the ingredient container 152 along a particular pathway, such as toward the outlet 156 and/or toward another agitator 162 installed within the food dispensing assembly 150.

In one implementation, the dispenser subassembly 160 can include an outlet cover 161 configured to transiently inhibit flow of ingredients from within the ingredient container 152 and through an outlet 156 of the ingredient container 152 in a closed position. In particular, the outlet cover 161 can be configured to oscillate between an open position—in which ingredients may flow through the outlet 156, such as for dispensation into a food container arranged on the conveyor unit 126 below the base platform 130—and the closed position, thereby: enabling dispensation of an ingredient for assembly of a food order specifying this ingredient; limiting unintentional release of ingredients (e.g., spilling, dripping) onto surfaces of the autonomous assembly zone 112 (e.g., walls, conveyor unit 126) and therefore minimizing frequency of required cleaning and/or maintenance due to ingredient spills; and/or limiting unintentional release of ingredients into food containers corresponding food orders excluding this particular ingredient.

Additionally, in another implementation, the base section 164 can include a set of feet configured to seat against the upper surface of the base platform 130 to support the food dispensing assembly 150 on the base platform 130 within the receptacle 124.

### 5.2.1 Drivetrain: Splined Connection

The dispenser subassembly 160 can include a set of drivetrains 166 (e.g., one, two, three) configured to transiently couple to the set of driveshafts 144 extending from the upper surface of the base platform 130 and therefore-responsive to actuation via the set of actuators 140—regulate actuation of the set of agitators 162 installed in the food dispensing assembly 150 and coupled to the set of drivetrains 166. In particular, each drivetrain 166, in the set of drivetrains 166, can be arranged within the base platform 130 in a particular location, such that the drivetrain 166 aligns with and mates with (e.g., inserts over) a corresponding driveshaft 144 of an actuator installed within the food preparation unit 120.

In one implementation, the drivetrain 166 includes: a set of mount sections (e.g., an internal-splined hub or gear) configured to mate with the set of driveshafts 144 extending from the set of actuators 140 arranged in a fixed configuration on the base platform 130 of the food preparation unit 120; and a set of coupling sections configured to transiently couple to the set of coupling features of the set of agitators 162 to mechanically couple the drivetrain 166 to the set of agitators 162. The base section 164 of the food dispensing assembly 150 can therefore be configured to include the set of mount sections arranged in a target configuration matched to the fixed arrangement of actuators —and thus the fixed arrangement of driveshafts 144—on the base platform 130 of the food preparation unit 120, such that in the assembled configuration the food dispensing assembly 150 seats within the receptacle 124 on the base platform 130 and the set of driveshafts 144 of the set of actuators 140 insert into and/or mate with the set of mount sections.

For example, the food preparation unit 120 can include a first actuator 140 arranged in a first position on the base platform 130 and including a first driveshaft 144 extending upward from the base platform 130 toward the receptacle 124 and defining an external spline section. The base section 164 of the food dispensing assembly 150 can include a drivetrain 166 including a first gear, in a set of gears, arranged in a second position within the base section 164 and defining an internal spline section configured to mate with the external spline section of the first driveshaft 144. To install the food dispensing assembly 150 in the food preparation unit 120, a user may therefore insert the food dispensing assembly 150 into the receptacle 124 (e.g., in a particular orientation) and the receptacle 124-exhibiting a fixed unit dimension corresponding to the rim of the food dispensing assembly 150-automatically aligns the internal spline section of the first gear with the external spline section of the first driveshaft 144, thereby mechanically coupling the drivetrain 166 to the first actuator 140 and rigidly locating the food dispensing assembly 150 within the receptacle 124 of the food preparation unit 120.

In one variation, the base section 164 of the food dispensing assembly 150 can define a set of mating features configured to enable alignment of the set of mount sections with the set of driveshafts 144 extending from the base platform 130. For example, the base section 164 can define a first aperture of a particular shape (e.g., ovular, elliptical, non-circular) arranged about a first mount section of the drivetrain 166. An operator may therefore ensure installation of the food dispensing assembly 150 in a target orientation by locating the first aperture over a corresponding feature on the base platform 130.

### 5.2.2 Suite of Agitators

Generally, the modular system 100 includes a suite of agitators 162 of varying geometries and configured to transiently couple to the food dispensing assembly 150 to agitate ingredients loaded in the ingredient container 152, such as by driving (e.g., pushing) units of an ingredient toward the outlet 156 of the ingredient container 152. In particular, the suite of agitators 162 (e.g., an auger, a rotating paddle wheel, a pusher) can be configured to transiently couple to the drivetrain 166 (and therefore mechanically couple to the set of actuators 140) integrated within the dispenser subassembly 160: to seat extending into the interior volume of the ingredient container 152 in a target orientation, such as horizontally or vertically; and to drive ingredients loaded in the ingredient container 152 along a target pathway-such as toward the outlet 156 of the ingredient container 152 and/or toward one or more additional agitators 162 installed in the food dispensing assembly 150—responsive to actuation via the set of actuators 140 and the drivetrain 166.

In one implementation, each agitator 162, in the suite of agitators 162, can be configured for agitating ingredients of a particular ingredient type(s). In particular, in this implementation, each agitator 162, in the suite of agitators 162, can define a set of agitator characteristics—such as a particular geometry, a particular shaft orientation (e.g., horizontal, vertical, diagonal), a particular pitch (e.g., short, long, fixed, variable), etc.—configured to promote dispensation of ingredients of a particular ingredient type according to a set of target dispense parameters defined for ingredients of the particular ingredient type. For example, the food dispensing assembly 150 can include a set of agitators 162 including: a spiral-shaped blade defining a central bore extending through an axis of the spiral-shaped blade; a central shaft including a spiral-shaped blade-defining a particular pitch offset between blades—extending from the central shaft; a central shaft including a set of paddles—defining a particular pitch offset between paddles-extending from the central shaft; etc. An operator may therefore load the food dispensing assembly 150 with a particular set of agitators 162—defining a particular set of agitator characteristics—matched to an ingredient assigned to the food dispensing assembly 150.

### 5.2.3 Variation: Agitator Cartridges

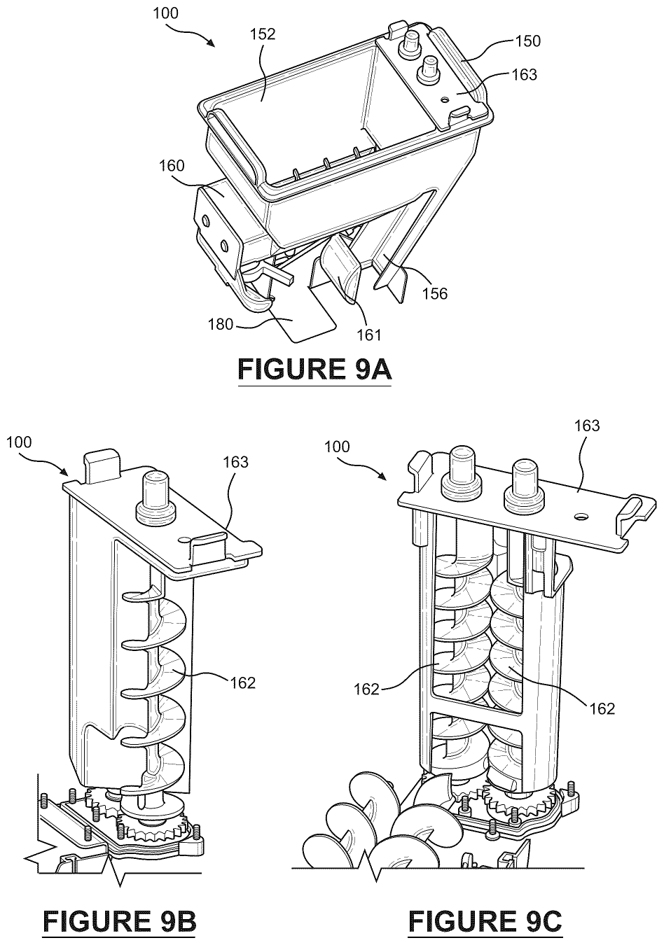

In one variation, the modular system 100 can include a suite of agitator cartridges 163, each cartridge including a set of agitators 162 (i.e., one or more) of varying geometries and configured to transiently couple to the food dispensing assembly 150, as shown in FIGS. 9A-9C. In particular, the suite of agitator cartridges 163 can include sets of agitator cartridges 163 corresponding to a particular size of food dispensing assembly 150 (e.g., a full-size food pan) to enable replacement of agitator cartridges 163 within a single food dispensing assembly 150 to accommodate different ingredients.

In one implementation, each agitator cartridge 163, in the suite of agitator cartridges 163, can be configured for agitating ingredients of a particular ingredient type(s). In particular, in this implementation, each agitator cartridge 163, in the suite of agitator cartridges 163, can include a set of agitators 162 (i.e., one or more) encapsulated by a cartridge housing configured to transiently couple the agitator cartridge 163 within the food dispensing assembly 150. In particular, each cartridge housing within a set of agitator cartridges 163 (i.e., defined for a particular size of food dispensing assembly 150) can maintain consistent outer dimensions (e.g., width) compatible with a particular size of food dispensing assembly 150. By maintaining consistent dimensions, each agitator cartridge 163, in a set of agitator cartridges 163 can be compatible with each food dispensing assembly 150 of the corresponding size.

Furthermore, each agitator 162 in the set of agitators 162 can define a set of agitator characteristics unique to the agitator 162, or a set of agitator characteristics similar to each other agitator 162 in the set of agitators 162.

In one example implementation, a first agitator cartridge 163 can include: a set of two vertical agitators 162; and a first cartridge housing partially encompassing the two vertical agitators 162 and configured to retain liquid to dispense liquid ingredients and/or ingredients exhibiting a target ratio of solids to liquids. Additionally, in this example implementation, a second agitator cartridge 163 can include: a vertical agitator 162; and a second cartridge housing extending proximal a first side of the vertical agitator 162 and configured to release liquid to dispense solid ingredients.

In this example implementation, in a first configuration with the dispenser receptacle 124 occupied by a food dispensing assembly 150 loaded with a first volume of a first ingredient type (e.g., sauce), occupying the dispenser receptacle 124, the food preparation unit 120 can be configured to actuate a first actuator 140: to rotate the first agitator cartridge 163 including the set of two vertical agitators 162 to drive the first ingredient type toward an outlet 156 of the food dispensing assembly 150 and to open the outlet 156 to dispense a serving of the first ingredient type toward the autonomous assembly zone 112.

Furthermore, in this example implementation, in a second configuration with the dispenser receptacle 124 occupied by the food dispensing assembly 150 loaded with the first volume of a second ingredient type (e.g., grape tomatoes), the food preparation unit 120 can be configured to actuate the first actuator 140: to rotate the second agitator cartridge 163 including the vertical agitator 162 to drive the second ingredient type toward an outlet 156 of the food dispensing assembly 150 and to open the outlet 156 to dispense a serving of the second ingredient type toward the autonomous assembly zone 112. Accordingly, each food dispensing assembly 150 can be reconfigured to include various agitators and agitator cartridges to accommodate various agitation requirements of different ingredients.

### 5.3 Motor Profile

In one variation, the food preparation unit 120 can access a motor profile (e.g., via the controller) defining operating characteristics (e.g., speed, operation interval) for a particular food dispensing assembly 150. In one example implementation, the modular system 100 can include a first food preparation unit 120 including: a first actuator 140; a second actuator 140; and a controller configured to access the motor profile defining rotation of the first actuator 140 and the second actuator 140 for a particular food dispensing assembly 150.

For example, in a first configuration with the dispenser receptacle 124 occupied by a first food dispensing assembly 150 loaded with a first volume of a first ingredient type, the controller can be configured to access a first motor profile defining rotation of the first actuator 140 and the second actuator 140 for the first food dispensing assembly 150. The controller can then: during a first time period, trigger the first actuator 140 to rotate in the first direction at a first speed according to the first motor profile; and, during a second time period succeeding the first time period, trigger the second actuator 140 to rotate in the first direction at a second speed according to the first motor profile.

Additionally or alternatively, in the preceding example implementation, in a second configuration with the dispenser receptacle 124 occupied by a second food dispensing assembly 150 loaded with the first volume of a second ingredient type, the controller can be configured to access a second motor profile defining rotation of the first actuator 140 and the second actuator 140 for the second food dispensing assembly 150. The controller can then: during the first time period, trigger the first actuator 140 to rotate in the first direction at a third speed, greater than the first and second speeds, according to the second motor profile. Thus, the modular system 100 can access the corresponding motor profile for a particular food dispensing assembly 150 and dynamically actuate the suite of actuators 140 based on the configuration of the food dispensing assemblies 150, thereby ensuring precise control over the dispensing process.

In one variation, the food preparation unit 120 can include one or more scanners 170 (e.g., an RFID reader) configured to scan a readable identifier 172-arranged on the first food dispensing assembly 150-upon installation of the food dispensing assembly 150 within the food preparation unit 120, as shown in FIG. 1B. The controller and/or a remote computer system can then access the scanner 170 to access the motor profile defining rotation of the first actuator 140 and the second actuator 140 for the food dispensing assembly 150 based on a first identifier associated with the first readable identifier 172 and scanned via the scanner 170.

### 5.4 Thermal Shield

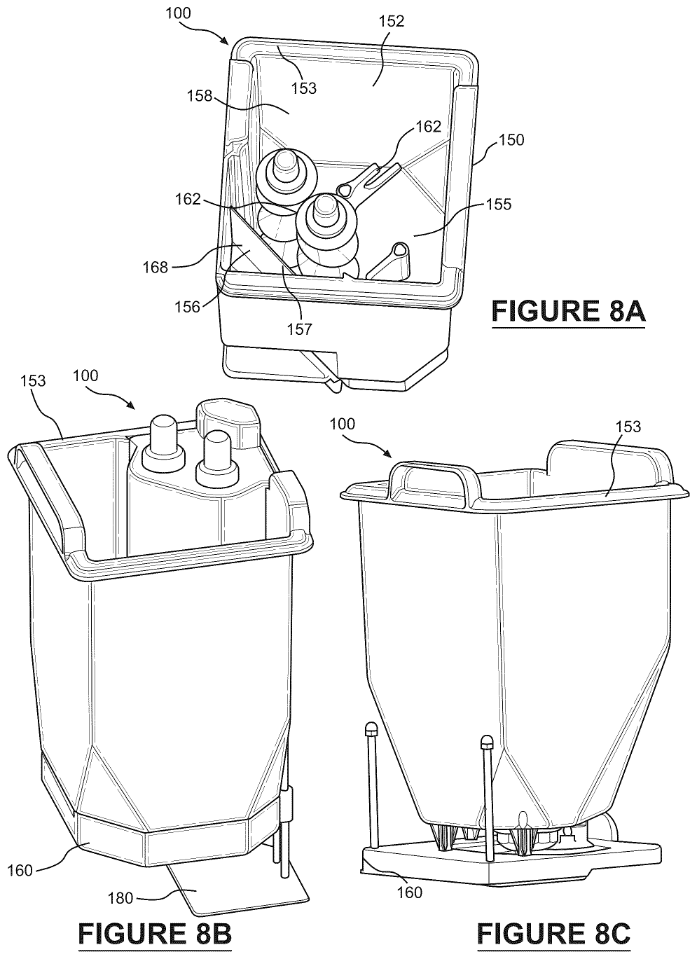

The food preparation unit 120 can define a thermally-controlled region including the receptacle 124 and configured to maintain a target temperature for a particular ingredient type. In one variation, the food dispensing assembly 150 includes a thermal shield 180 coupled to a bottom of the food dispensing assembly 150 and configured to reduce air flow between the thermally-controlled region and the autonomous assembly zone 112, as shown in FIGS. 8B and 9A. In particular, the thermal shield 180 can define a barrier below the ingredient container 152 configured to inhibit mixing of air from the autonomous assembly zone 112 with the heated or cooled air within the thermally-controlled region.

As shown in FIGS. 8B and 8C, in one example, a food dispensing assembly 150 includes a thermal shield 180 configured: to retract upward toward the upper rim 153 when the food dispensing assembly 150 is not installed within the receptacle 124 (i.e., the unassembled configuration) to enable easier handling and storage; and to lower downward away from the upper rim 153 when the food dispensing assembly 150 is installed within the receptacle 124 (i.e., the assembled configuration) to effectively inhibit air flow and maintain the target temperature within the thermally-controlled region. By integrating the thermal shield 180 directly into the food dispensing assemblies 150, each food dispensing assembly 150 can be moved within the modular system 100 as needed to accommodate varying assembly line configurations while maintaining the specific thermal requirements of each ingredient type.

### 5.5 Manual+Autonomous Assembly

The modular system 100 can be configured to simultaneously support manual preparation of food products by a worker (e.g., an employee) within the manual assembly zone 114 and autonomous preparation of food products within the autonomous assembly zone 112.

In one implementation, the food dispensing assembly 150 includes the ingredient container 152 configured to transiently store an ingredient type within an interior volume of the ingredient container 152. In particular, the receptacle 124 can be configured to locate the food dispensing assembly 150 within the food preparation unit 120, such that the upper rim 153 of the ingredient container 152-loaded with and/or configured to be loaded with ingredients-seats approximately flush with the manual assembly zone 114 (e.g., in an assembled configuration). The ingredient container 152 can define: an upper opening 154 (i.e., defined by the upper rim 153) configured to expose ingredients from the interior volume of the ingredient container 152 toward the manual assembly zone 114; and an outlet 156 configured to release volumes of ingredients from the interior volume of the ingredient container 152 toward the autonomous assembly zone 112 (e.g., toward a food container).

Thus, the food preparation unit 120 defines: the manual assembly zone 114 including the manual food preparation surface 122 and encompassing the upper opening 154 of the ingredient container 152 and housing manual preparation of food products; and the autonomous assembly zone 112 arranged below the manual assembly zone 114 and extending along a longitudinal assembly axis defined by the sequence of food preparation units 120 and housing autonomous preparation of food products. Furthermore, the food preparation unit 120 can house the manual food preparation surface 122 at a working height range (e.g., between 36 inches and 38 inches) to facilitate access to the ingredients stored in the ingredient container 152.

In one example, the modular system 100 can be configured for installation in a food service establishment to augment manual preparation with autonomous preparation by fulfilling orders submitted online via remote patrons within the autonomous assembly zone 112, while orders entered by on-site patrons are simultaneously fulfilled in the manual assembly zone 114 (e.g., by a worker). Therefore, the modular system 100 can: facilitate manual preparation of food products by providing access to ingredients from above (e.g., for access by a worker); and augment manual preparation by autonomously assembling food in the autonomous assembly zone 112.

### 6. Kit of Food Dispensing Assemblies

The modular system 100 can be configured to receive a kit of food dispensing assemblies 150 including a quantity of different-sized food dispensing assemblies 150. For example, the kit of food dispensing assemblies 150 can include: a first food dispensing assembly 150 (e.g., full-size food dispensing assembly 150) storing a first volume of a first ingredient type; a set of two food dispensing assemblies 150 (e.g., two half-size food dispensing assemblies 150) storing a second volume of a second set of ingredient types, the second volume approximately one half of the first volume; a set of three food dispensing assemblies 150 (e.g., three third-size food dispensing assemblies 150) storing a third volume of a third set of ingredient types, the third volume approximately one third of the first volume; and/or a set of six food dispensing assemblies 150 (e.g., six sixth-size food dispensing assemblies 150) storing a fourth volume of a fourth set of ingredient types, the fourth volume approximately one sixth of the first volume.

In one example implementation, the receptacle 124 can be configured to: transiently receive the first food dispensing assembly 150 in a first configuration; transiently receive the set of two food dispensing assemblies 150, in replacement of the first food dispensing assembly 150, in a second configuration; transiently receive the set of three food dispensing assemblies 150, in replacement of the first food dispensing assembly 150 and/or the set of two food dispensing assemblies 150, in a third configuration; and/or transiently receive the set of six food dispensing assemblies 150, in replacement of the first food dispensing assembly 150, the set of two food dispensing assemblies 150, and/or the set of three food dispensing assemblies 150, in a fourth configuration.

Furthermore, in this example implementation, the set of actuators 140 can be configured to selectively actuate to trigger release of each ingredient type and/or set of ingredient types from the food dispensing assemblies 150 toward the autonomous assembly zone 112. Thus, the modular system 100 can be reconfigured by installing, removing, and/or replacing food dispensing assemblies 150 of various dispenser subassembly types within the dispenser receptacle 124 over time in order to accommodate dispensation of different ingredients and/or to rearrange a distribution ingredients, regardless of variation between dispenser subassembly types.

### 7. Food Dispensing Assembly Configurations

As described above, the modular system 100 can include a kit of food dispensing assemblies 150 assembled in various configurations, such as based on a size of each food dispensing assembly 150 and/or a type of ingredient loaded in the food dispensing assembly 150. Furthermore, over time, each food dispensing assembly 150, in the set of food dispensing assemblies 150, can be reassembled in a different configuration, such as by replacing a first agitator 162-corresponding to a first ingredient type—with a second agitator 162 corresponding to a second ingredient type.

### 7.1 “Third-Size” Food Dispensing Assembly

In one implementation, the set of food dispensing assemblies 150 can include a “third-size” food dispensing assembly 150—including an ingredient container 152 defining a standard cross-section of a standard third-size food pan (or “hotel pan”) at the upper rim 153 of the ingredient container 152. For example, the upper rim 153 of the ingredient container 152 can define a length of approximately 7.25 inches (e.g., within five percent) and a width of approximately 12.75 inches (e.g., within five percent).

The third-size food dispensing assembly 150 can include a dispenser subassembly 160 configured to couple to the set of actuators 140—arranged in a fixed arrangement on the base platform 130 of the food preparation unit 120—and drive ingredients loaded in the ingredient container 152 toward the outlet 156 responsive to actuation via the set of actuators 140. In particular, the base platform 130 can include: a first actuator 140 arranged on a first side of the center bore 134 and including a first driveshaft 144—defining an external splined section—extending upward from the base platform 130 toward the receptacle 124; and a second actuator 140 arranged on a second side of the center bore 134 and including a second driveshaft 144—defining a second external splined section—extending upward from the base platform 130 toward the receptacle 124 (e.g., approximately parallel the first driveshaft 144). The dispenser subassembly 160 can include: a base section 164 configured to seat on the upper surface of the base platform 130; a first drivetrain 166—integrated into a first side of the base section 164 configured to seat over the first side of the base platform 130-including a first gear defining an internal spline section configured to insert over and mate with the external splined section of the first driveshaft 144 to mechanically couple the first drivetrain 166 to the first actuator 140; and a second drivetrain 166-integrated into a second side of the base section 164 configured to seat over the second side of the base platform 130-including a second gear defining an internal spline section configured to insert over and mate with the external splined section of the second driveshaft 144 to mechanically couple the second drivetrain 166 to the second actuator 140.

### 7.1.1 Example Configuration: Horizontal+Vertical Agitators

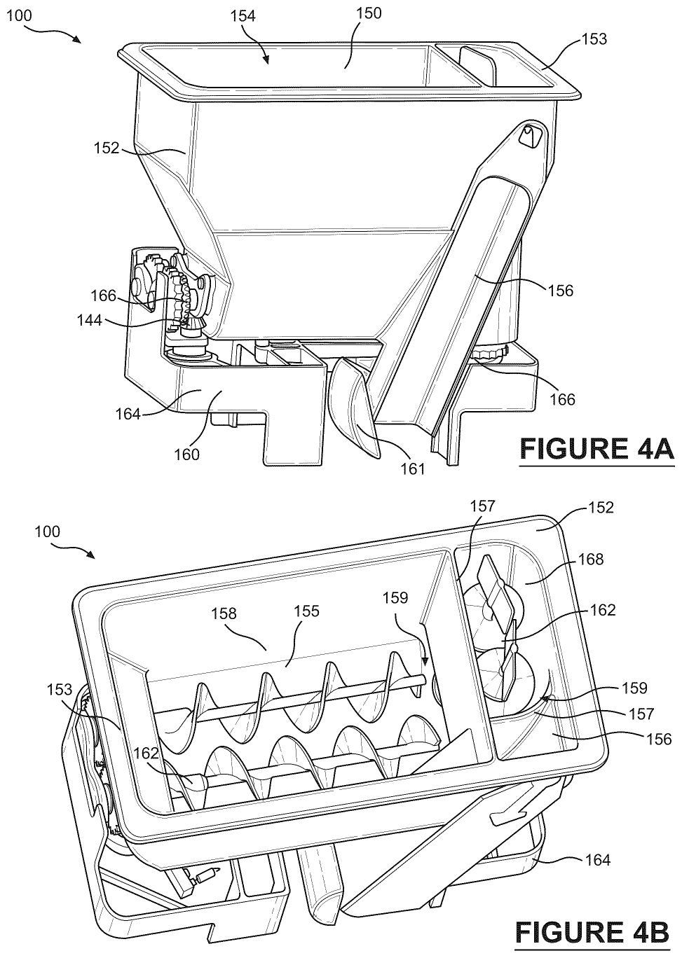

As shown in FIGS. 4A and 4B, in one example configuration, a third-size food dispensing assembly 150 can include an ingredient container 152 defining: a primary region 158 configured for loading with units of an ingredient, in a first set of ingredients (e.g., chicken, steak, rice, corn, tomato); a secondary region 168—fluidly coupled (e.g., via flow of ingredients) to the primary region 158; and an outlet 156 fluidly coupled to the secondary region 168. In particular, the ingredient container 152 includes a first barrier 157 (e.g., a wall, a gate) interposed between the primary region 166 and the secondary region 168 of the ingredient container 152; and a second barrier 157 interposed between the secondary region 168 and the outlet 156. The first barrier 157 can define a bottom edge arranged at a first height above the bottom surface 155 of the ingredient container 152. Furthermore, the second barrier 157 can define an upper edge arranged at a second height below the upper rim 153 of the ingredient container 152. The ingredient container 152 can therefore define: a first opening 159—arranged below the first barrier 157—configured to enable flow of ingredients from the primary region 158 into the secondary region 168; and a second opening 159—arranged above the second barrier 157—configured to enable flow of ingredients from the secondary region 168 into the outlet 156.

In this example configuration, the third-size food dispensing assembly 150 can include a set of two horizontal agitators 162 of a first geometry and configured to: mechanically couple to the first drivetrain 166 and seat extending across the primary region 158 of the ingredient container 152; and drive ingredients horizontally-through the first opening 159—toward the secondary region 168 of the ingredient container 152 responsive to rotation in a first direction via actuation of the first drivetrain 166 by the first actuator 140. In addition, the third-size food dispensing assembly 150 can include a set two of vertical agitators 162 of a second geometry and configured to: mechanically couple to the first drivetrain 166 and seat extending across the secondary region 168 of the ingredient container 152; and drive ingredients vertically upward and horizontally—through the second opening 159-toward the outlet 156 of the ingredient container 152 responsive to rotation in a second direction via actuation of the second drivetrain 166 by the second actuator 140.

By driving the ingredients vertically upward within the ingredient container 152 and toward the outlet 156, the set of vertical agitators 162 can promote flow of solid ingredients (e.g., chicken, corn, tomato) toward the outlet 156 while limiting flow of fluid ingredients (e.g., braise, corn juice, tomato juice) toward the outlet 156. The set of vertical agitators 162 can therefore be configured to “lift” or drive solid ingredients vertically upward while enabling fluid ingredients to flow off of surfaces of these vertical agitators 162 and therefore downward into the ingredient container 152. Furthermore, in one variation, the set of vertical agitators 162 can be configured to promote release of an amount of an ingredient-via the outlet 156-exhibiting a target ratio of solids to liquids. For example, the set of vertical agitators 162 can be configured to define a target distance—between each vertical agitator 162 and a wall of the ingredient container 152—matched to the target ratio and/or operate at a target speed (e.g., rotational speed) matched to the target ratio.

Over time, an operator may replace one or more agitators 162 in the first and/or second set of agitators 162 and/or replace the second set of agitators 162 with an agitator cartridge 163 based on a particular ingredient, in the first set of ingredients, loaded in the third-size food dispensing assembly 150.

Additionally, in this example configuration, the dispenser subassembly 160 can include an outlet cover 161 configured to: cover the outlet 156 to prevent release of ingredients from the outlet 156 in a closed position; and rotate toward an open position to enable release of ingredients from the outlet 156. To enable rotation of the outlet cover 161, the first drivetrain 166 can be configured to regulate actuation of both the set of horizontal agitators 162 and the outlet cover 161. In particular, the first actuator 140 can be configured to: rotate the first gear—coupled to the first driveshaft 144—in a first direction to trigger actuation of the set of horizontal agitators 162 and drive (and/or maintain) the outlet cover 161 toward the open position; and rotate the first gear in a second direction—opposite the first direction—to halt actuation of the set of horizontal agitators 162 and drive (and/or maintain) the outlet cover 161 toward the closed position. The first actuator 140 can therefore dually regulate actuation of both the outlet cover 161 and the set of horizontal agitators 162.

### 7.1.2 Example Configuration: Agitator Arms

Additionally or alternatively, in another example configuration, a third-size food dispensing assembly 150 can include an ingredient container 152 defining: a primary region 158 configured for loading with units of an ingredient, in a second set of ingredients, such as including shredded cheeses and/or leafy greens; and an outlet 156 fluidly coupled to the primary region 158 and integrated into the bottom surface 155 of the ingredient container 152, as shown in FIG. 6. In this example configuration, the third-size food dispensing assembly 150 can be configured to receive and locate a set of two horizontal agitators 162—transiently coupled to the first and second drivetrains 166 of the dispenser subassembly 160 and extending horizontally across the interior volume of the ingredient container 152—configured to drive ingredients downward toward the outlet 156.

Furthermore, in this example configuration, the third-size food dispensing assembly 150 can include an outlet cover 161: defining a central axis; including a first cover section configured to rotate in a first direction—away from the central axis—to enable flow of ingredients from the interior volume of the container toward the autonomous assembly zone 112; and a second cover section configured to rotate in a second direction—away from the central axis and opposite the first direction—to enable flow of ingredients from the interior volume of the container toward the autonomous assembly zone 112. To enable rotation of the outlet cover 161, the first drivetrain 166 can be mechanically coupled to both the outlet cover 161 and one or more horizontal agitators 162 in the set of two horizontal agitators 162. In particular, the first actuator 140 can be configured to: rotate the first gear—coupled to the first driveshaft 144—in a first direction to trigger actuation of one or both horizontal agitators 162 and drive (and/or maintain) the first and second cover sections away from the central axis (e.g., via a cam and gear mechanism) toward an open position; and rotate the first gear in a second direction—opposite the first direction—to halt actuation of the set of horizontal agitators 162 and drive (and/or maintain) the first and second cover sections toward the central axis in a closed position. The first actuator 140 can therefore dually regulate actuation of both the outlet cover 161 and the set of horizontal actuators.

### 7.1.3 Example Configuration: Horizontal Agitator+Deflector

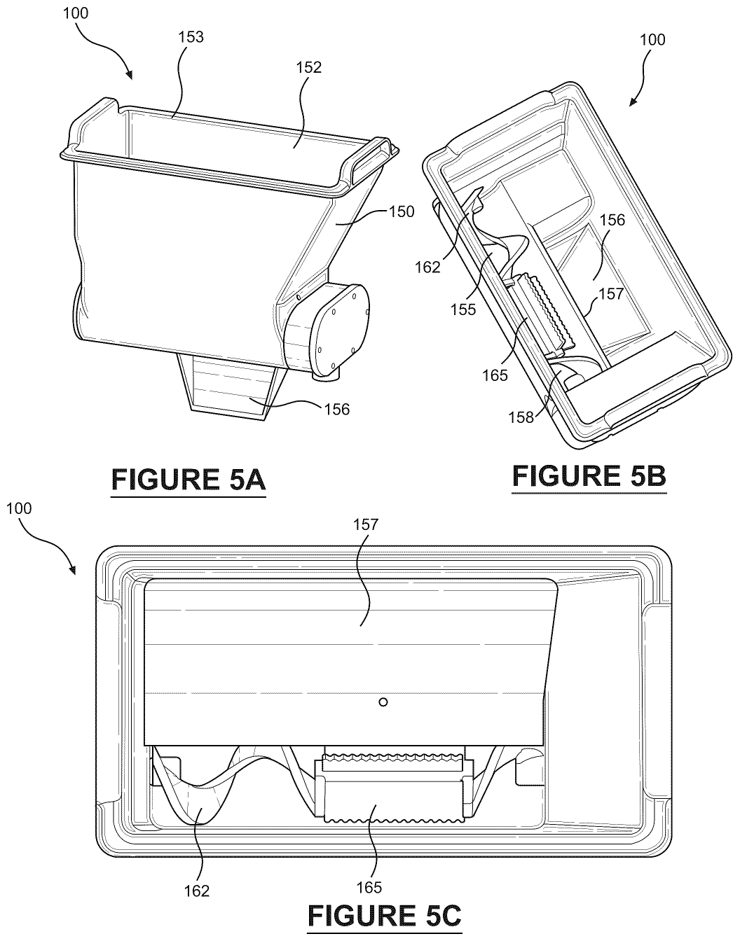

Additionally or alternatively, in another example configuration, a third-size food dispensing assembly 150 can include an ingredient container 152 defining: a primary region 158 configured for loading with units of an ingredient, in a third set of ingredients (e.g., chicken, steak); and an outlet 156 fluidly coupled (e.g., via flow of ingredients) to the primary region 158, as shown in FIGS. 5A-5C. In particular, the ingredient container 152 includes: a first barrier 157 (e.g., a wall, a gate) interposed between the primary region 158 and the outlet 156 and defining an upper edge arranged at a first height above a bottom surface 155 of the ingredient container 152; and a second barrier 157 (e.g., a wall, a gate, a deflector) transiently installed above the outlet 156 and defining a lower edge proximal the primary region 158 arranged at a second height, greater than the first height, above the bottom surface 155 of the ingredient container 152. The ingredient container 152 can therefore define an opening—arranged above the first barrier 157 and below the second barrier 157 (i.e., between the upper edge of the first barrier 157 and the lower edge of the second barrier 157)—configured to enable flow of ingredients from the primary region 158 into the outlet 156.

In this example configuration, the third-size food dispensing assembly 150 can include a horizontal agitator 162 configured: to mechanically couple to the first drivetrain 166 and seat extending across the primary region 158 of the ingredient container 152; and to drive ingredients stored in the ingredient container 152 vertically upward and horizontally through the opening and over the first barrier 157 toward the outlet 156 responsive to rotation in a first direction via actuation of the first drivetrain 166 by the first actuator 140. In particular, the horizontal agitator 162 can include a mixing blade 165 configured to drive ingredients vertically upward and horizontally through the opening and over the first barrier 157 toward the outlet 156.

Furthermore, upon loading ingredients into the ingredient container 152, the second barrier 157 can be configured to deflect ingredients away from the outlet 156 such that the ingredients are directed toward and/or dispensed into the primary region 158. By deflecting ingredients away from the outlet 156, the second barrier 157 can promote flow of both solid ingredients (e.g., chicken) and liquid ingredients (e.g., chicken juice) toward the outlet 156.

The horizontal agitator 162 can therefore be configured: to mix liquid and solid ingredients in the primary region 158 to dispense ingredients exhibiting a target ratio of solids to liquids (i.e., a target moisture content); and to lift or drive solid ingredients vertically upward and horizontally through the opening 159 via the mixing blade.

### 7.2 “Sixth-Size” Food Dispensing Assembly

In another implementation, the set of food dispensing assemblies 150 can include a “sixth-size” food dispensing assembly 150—including an ingredient container 152 defining a standard cross-section of a standard sixth-size food pan. For example, the upper rim 153 of the ingredient container 152 can define a length of approximately 7.25 inches (e.g., within five percent) and a width of approximately 6.40 inches (e.g., within five percent).

The sixth-size food dispensing assembly 150 can include a dispenser subassembly 160 configured to couple to a first actuator 140 on the base platform 130 and drive ingredients toward the outlet 156 responsive to actuation of the first actuator 140 accordingly. In particular, the base platform 130 can include: a first actuator 140 arranged on a first side of the center bore 134 and including a first driveshaft 144—defining an external splined section—extending upward from the base platform 130 toward the receptacle 124; and a second actuator 140 arranged on a second side of the center bore 134 and including a second driveshaft 144—defining a second external splined section—extending upward from the base platform 130 toward the receptacle 124 (e.g., approximately parallel the first driveshaft 144). The dispenser subassembly 160 can include: a first drivetrain 166—configured to seat over the first side of the base platform 130—defining an internal spline section (e.g., an internal spline gear) configured to insert over and mate with the external splined section of the first driveshaft 144 to mechanically couple the first drivetrain 166 to the first actuator 140. Furthermore, a second sixth-size food dispensing assembly 150 can install adjacent the sixth-size food dispensing assembly 150 within the receptacle 124. In particular, the second sixth-size food dispensing assembly 150 can include a second dispenser subassembly 160 including a second drivetrain 166—configured to seat over the second side of the base platform 130—including an internal spline section configured to insert over and mate with the external splined section of the second driveshaft 144 to mechanically couple the second drivetrain 166 to the second actuator 140.

### 7.2.1 Example Configuration: Agitator+Corner Outlet

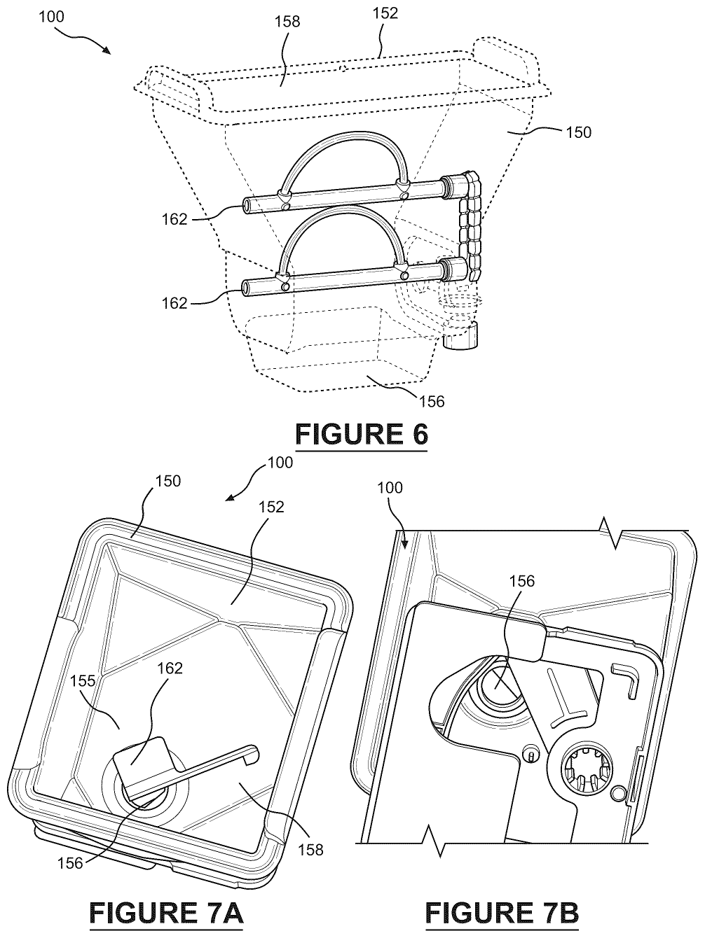

In one example configuration, a sixth-size food dispensing assembly 150 includes an ingredient container 152 defining: an internal volume configured for loading with units of an ingredient, in a fourth set of ingredients, such as including sauces, salsas, dressings, etc.; and an outlet 156 (e.g., a drain) integrated into a corner of a bottom surface 155 of the ingredient container 152, as shown in FIGS. 7A and 7B. By locating the outlet 156 in the corner of the bottom surface 155 of the ingredient container 152, the food dispensing assembly 150 can seat over the first side of the base platform 130—with the first drivetrain 166 coupled to the first driveshaft 144—and locate the outlet 156 over the central bore of the base platform 130, thereby enabling flow of ingredients toward the autonomous assembly zone 112.

The sixth-size food dispensing assembly 150 can be configured to receive and locate a set of agitators 162—transiently coupled to the first drivetrain 166 of the dispenser subassembly 160—configured to both enable flow of ingredients through the outlet 156 and/or prevent build-up of ingredients over the outlet 156. In particular, in this example configuration, the first actuator 140 can rotate the driveshaft 144 in a first direction to actuate a first agitator 162 mechanically coupled to the driveshaft 144 (e.g., via the first drivetrain 166) and configured to sweep across the outlet 156 (e.g., parallel the bottom surface 155 of the ingredient container 152) to drive solid ingredients away from the outlet 156 and enable flow of liquid and/or low-viscosity ingredients through the outlet 156.

Furthermore, in this example configuration, the sixth-size food dispensing assembly 150 can include a set of outlet covers 161 configured to modify a size of the outlet 156 to enable dispensation of different ingredient types at varying dispense rates. For example, the sixth-size food dispensing assembly 150 can include a first outlet cover 161—defining a first diameter—arranged within the outlet 156 of a second diameter exceeding the first diameter. In this example, the sixth-size food dispensing assembly 150 can be configured to dispense ingredients through the outlet 156 at a first dispense rate. Additionally or alternatively, the sixth-size food dispensing assembly 150 can include a second outlet cover 161—defining a third diameter exceeding the first diameter and less than the second diameter—arranged within the outlet 156. In this configuration, the sixth-size food dispensing assembly 150 can be configured to dispense ingredients through the outlet 156 at a second dispense rate falling below the first dispense rate.

### 7.2.2 Example Configuration: Agitator Arms+Vertical Agitators

Additionally or alternatively, in another example configuration, a sixth-size food dispensing assembly 150 includes an ingredient container 152 defining: a primary region 158 configured for loading with units of an ingredient, in a first set of ingredients (e.g., corn, fruits); a secondary region 168—fluidly coupled (e.g., via flow of ingredients) to the primary region 158; and an outlet 156 arranged proximal a corner of the ingredient container 152 and fluidly coupled to the secondary region 168, as shown in FIGS. 8A-8C. By locating the outlet 156 in the corner of the ingredient container 152, the food dispensing assembly 150 can seat over the first side of the base platform 130—with the first drivetrain 166 coupled to the first driveshaft 144—and locate the outlet 156 over the central bore of the base platform 130, thereby enabling flow of ingredients toward the autonomous assembly zone 112.

In particular, the ingredient container 152 includes a first barrier 157 (e.g., a wall, a gate) interposed between the primary region 166 and the secondary region 168 of the ingredient container 152; and a second barrier 157 interposed between the secondary region 168 and the outlet 156. The first barrier 157 can define a bottom edge arranged at a first height above the bottom surface 155 of the ingredient container 152. Furthermore, the second barrier 157 can define an upper edge arranged at a second height below the upper rim 153 of the ingredient container 152. The ingredient container 152 can therefore define: a first opening 159—arranged below the first barrier 157—configured to enable flow of ingredients from the primary region 158 into the secondary region 168; and a second opening 159—arranged above the second barrier 157—configured to enable flow of ingredients from the secondary region 168 into the outlet 156.

In this example configuration, the sixth-size food dispensing assembly 150 can include a set of two agitator 162 arms configured to: mechanically couple to the first drivetrain 166 and seat near a bottom of the primary region 158 of the ingredient container 152; and drive ingredients horizontally—through the first opening—toward the secondary region 168 of the ingredient container 152 responsive to rotation in a first direction via actuation of the first drivetrain 166 by the first actuator 140. In addition, the sixth-size food dispensing assembly 150 can include a set two of vertical agitators 162 configured to: mechanically couple to the first drivetrain 166 and seat extending across the secondary region 168 of the ingredient container 152; and drive ingredients vertically upward and horizontally—through the second opening—toward the outlet 156 of the ingredient container 152 responsive to rotation in the first direction via actuation of the first drivetrain 166 by the first actuator 140.

By driving the ingredients horizontally—through the first opening 159—toward the secondary region 168 of the ingredient container 152, the set of two agitator 162 arms can continuously agitate (i.e., stir and move) ingredients at the bottom of the primary region 158, thereby preventing stagnation and buildup within potential stagnation zones of the ingredient container 152 by consistently directing ingredients toward the set of vertical agitators 162 for dispensing. Furthermore, by driving the ingredients vertically upward within the ingredient container 152 and toward the outlet 156, the set of vertical agitators 162 can promote flow of solid ingredients (e.g., corn, fruit) toward the outlet 156 while limiting flow of fluid ingredients (e.g., corn juice, fruit juice) toward the outlet 156. The set of vertical agitators 162 can therefore be configured to “lift” or drive solid ingredients vertically upward while enabling fluid ingredients to flow off of surfaces of these vertical agitators 162 and therefore downward into the ingredient container 152.

### 8. Installation: Dispenser Identification

In one variation, each dispenser subassembly 160 can include a (unique) readable identifier 172 (e.g., an RFID tag)—associated with the dispenser subassembly 160—arranged on the dispenser subassembly 160 and configured to enable verification of installation of the dispenser subassembly 160 in a corresponding food preparation unit 120 (e.g., assigned to the dispenser subassembly 160 for a particular time period) and/or in a particular orientation within the corresponding food preparation unit 120. In this variation, the food preparation unit 120 can include one or more scanners 170 (e.g., an RFID reader) configured to scan the readable identifier 172 upon installation of the dispenser subassembly 160 within the food preparation unit 120. The controller and/or a remote computer system can then access the scanner 170 to confirm installation of the dispenser subassembly 160—in a particular orientation—within the dispenser subassembly 160 based on the readable identifier 172 captured via the scanner 170.

In one example, a first food preparation unit 120, in the sequence of food preparation units 120, includes a base platform 130 defining a set of three dispenser seat sections 132—including a first dispenser seat section 132, a second dispenser seat section 132, and a third dispenser seat section 132—configured to receive and locate a combination of food dispensing assemblies 150 within the first food preparation unit 120. In particular, the base platform 130 can include: a first actuator 140 integrated into the first dispenser seat section 132 and defining a first driveshaft 144 extending from a first side of an upper surface of the base platform 130; a second actuator 140 integrated into the first dispenser seat section 132 and defining a second driveshaft 144 extending from a second side of the upper surface, the center bore 134 extending between the first and second sides; a first RFID reader arranged proximal the first dispenser seat section 132 and coupled to walls of the first side of the base platform 130; and a second RFID reader arranged proximal the second dispenser seat section 132 and coupled to walls of the second side of the base platform 130.

In this example, a first dispenser subassembly 160 includes: a first RFID tag—defining a first identifier—arranged on a first side of the base section 164 configured to seat over the first side of the base platform 130 in a target orientation, such that an outlet 156 of the first dispenser subassembly 160 seats above and/or within the center bore 134; a first drivetrain 166—integrated into the first side of the base section 164—defining a first receiving section configured to mate with the first driveshaft 144 in the target orientation; and a second drivetrain 166—integrated into a second side of the base section 164 opposite the first side—defining a second receiving section configured to mate with the second driveshaft 144 in the target orientation.

An operator may therefore insert the first dispenser subassembly 160 into a receptacle 124 of the first food preparation unit 120 to seat the first dispenser subassembly 160 within the first dispenser seat section 132 and thus couple the first receiving section to the first driveshaft 144 and couple the second receiving section to the second driveshaft 144. The controller can then: access a target configuration—defined for the first food preparation unit 120—defining a target identifier of a dispenser subassembly 160 assigned to the first dispenser seat section 132; trigger the first RFID reader to scan for presence of an RFID tag within a threshold radius of the first RFID reader; and, in response to detecting the first RFID tag within the threshold radius of the RFID reader, retrieve the first identifier defined by the first RFID tag. Then, in response to the first identifier corresponding to the target identifier, the controller can verify installation of the first dispenser subassembly 160 in the target configuration.

Alternatively, in response to detecting absence of the first RFID tag within the threshold radius of the first RFID reader, the controller can: trigger the second RFID reader to scan for presence of an RFID tag within a threshold radius of the second RFID reader; in response to detecting the first RFID tag within the threshold radius of the second RFID reader, retrieve the first identifier defined by the first RFID tag; and, in response to the first identifier corresponding to the target identifier, the controller can: verify presence of the first dispenser subassembly 160 and withhold verification of installation; and trigger an alert panel and/or a display of a computing device-integrated into the modular system 100—to signal improper installation of the first dispenser subassembly 160 within the food preparation unit 120 to the operator.

In this example, the base platform 130 can further include: a third RFID reader arranged proximal the second dispenser seat section 132 and coupled to walls of the first side of the base platform 130; and a fourth RFID reader arranged proximal the second dispenser seat section 132 and coupled to walls of the second side of the base platform 130; a fifth RFID reader arranged proximal the third dispenser seat section 132 and coupled to walls of the first side of the base platform 130; and a sixth RFID reader arranged proximal the third dispenser seat section 132 and coupled to walls of the second side of the base platform 130. The controller can therefore similarly confirm or reject verification of installation of dispenser subassemblies 160 within the second and third dispenser seat sections 132 based on detection of RFID tags—such as by a particular RFID reader—on these dispenser subassemblies 160.

Additionally or alternatively, in another example, the modular system 100 can include: a set of detectable features (e.g., QR codes or barcodes, patterns, colors, shapes) arranged on the set of dispenser subassemblies 160; and a set of optical sensors installed within the food preparation unit 120 and configured to capture images of the set of detectable features for verification of installation of a particular dispenser subassembly 160—in a particular orientation—within the food preparation unit 120.

### 9. Conveyor Unit

The food preparation unit 120 can include a conveyor unit 126 arranged within the autonomous assembly zone 112 and configured to traverse a food container under the dispenser receptacle 124 and through the autonomous assembly zone 112. In particular, the conveyor unit 126 can be configured to: locate the food container below a particular food dispensing assembly 150 to receive a serving of the ingredient type stored in the food dispensing assembly 150; and, upon dispensing the ingredient type, locate the food container in a new position below a different food dispensing assembly 150 to receive another ingredient.

In one implementation, the modular system 100 can include a first food preparation unit 120 and a controller configured to: receive a food order (e.g., an online order from a patron) indicating a first ingredient type; trigger a first conveyor unit 126—arranged within a first autonomous assembly zone 112 arranged within the first food preparation unit 120—to advance by a first distance to locate the food container in a first position aligned with a first outlet 156 of a first food dispensing assembly 150 occupying the first food preparation unit 120; and trigger the first food dispensing assembly 150 to dispense a first serving of the first ingredient type into the food container.

In one variation, the modular system 100 can include the first food preparation unit 120, a second food preparation unit 120 adjacent the first food preparation unit 120, and the controller configured to, in response to receiving the food order indicating the first ingredient type and a second ingredient type: trigger the first conveyor unit 126 to advance by a second distance to transfer the food container from the first autonomous assembly zone 112 to a second autonomous assembly zone 112 arranged within the second food preparation unit 120; trigger the second conveyor unit 126 to advance by a third distance to locate the food container in a second position aligned with a second outlet 156 of a second food dispensing assembly 150 occupying the second food preparation unit 120; and trigger the second food dispensing assembly 150 to dispense a second serving of the second ingredient type into the food container. Therefore, the modular system 100 can efficiently assemble orders by autonomously transferring a food container between multiple food preparation units 120, ensuring that each container receives the correct sequence and quantity of ingredients as specified in the order.

### 10. Controller

The modular system 100 can include a controller configured to intake food orders from patrons and to selectively actuate the food processing and dispensing modules to construct instances of a food product according to these food orders. More specifically, the autonomous assembly zone 112 can include an integrated controller configured to: receive or access orders submitted by patrons via a user interface (e.g., arranged on a customer-facing facade of the modular system 100, arranged within a food service establishment (e.g., a ghost kitchen), or within a native food ordering application executing on user's mobile computing device) and/or via direct interaction with an employee; and handle autonomous fulfillment of these orders by triggering actuation of food dispensing assemblies 150 in the sequence of food preparation units 120.

The autonomous assembly zone 112 can also include a wireless communication module coupled to the controller and configured to: receive food orders for patrons; communicate errors, order fulfillment data, and/or fill status of food dispensing assemblies 150 in the modular system 100 to a remote computer system; and receive control-related updates executable by the controller when processing food orders. Alternatively, the controller and wireless communication module (and/or other controls- and communications-related subsystems) can be arranged in a controls module configured to transiently install in a modular system 100.

In one variation, food dispensing assemblies 150 include a sub-controller configured to locally control dispensation of metered volumes of an ingredient contained in the food dispensing assembly 150—such as by implementing closed-loop controls to drive actuators 140 in the food preparation unit 120 based on outputs of various sensors integrated into the food dispensing assembly 150—responsive to receipt of a command from the controller to dispense this amount of the ingredient.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A modular system comprising:
a food preparation unit configured to install in a sequence of food preparation units and comprising:
a manual food preparation surface;
an autonomous assembly zone arranged below the manual food preparation surface;
a dispenser receptacle arranged over the autonomous assembly zone and adjacent the manual food preparation surface;
a first conveyor unit arranged within the autonomous assembly zone and configured to traverse a food container under the dispenser receptacle and through the autonomous assembly zone; and
a first set of actuators adjacent the dispenser receptacle and configured to:
in a first configuration with the dispenser receptacle occupied by a first food dispensing assembly loaded with a first volume of a first ingredient type:
actuate a first actuator to rotate a first agitator in the first food dispensing assembly to drive the first ingredient type toward a first outlet of the first food dispensing assembly; and
actuate a second actuator to open the first outlet to dispense a first serving of the first ingredient type toward the autonomous assembly zone; and
in a second configuration with the dispenser receptacle occupied by a second food dispensing assembly loaded with the first volume of a second ingredient type:
actuate the first actuator to rotate a first set of agitators in the second food dispensing assembly to drive the second ingredient type toward a second set of agitators in the second food dispensing assembly; and
actuate the second actuator to rotate the second set of agitators to drive the second ingredient type toward a second outlet of the second food dispensing assembly and to open the second outlet to dispense a second serving of the second ingredient type toward the autonomous assembly zone.

2. The modular system of claim 1:
further comprising the first food dispensing assembly comprising:
an ingredient container configured to transiently store the first ingredient type within an interior volume of the ingredient container, the ingredient container defining:
an upper rim configured to seat approximately flush the manual food preparation surface;
an upper opening defined by the upper rim and configured to expose the first ingredient type from the interior volume of the ingredient container toward the manual food preparation surface; and
the first outlet configured to transiently release volumes of the first ingredient type from the interior volume of the ingredient container toward the autonomous assembly zone; and
wherein the food preparation unit:
defines a manual assembly zone encompassing the manual food preparation surface and the upper opening of the ingredient container;
defines the autonomous assembly zone:
below the manual assembly zone;
extending along a longitudinal assembly axis; and
housing autonomous preparation of food products; and
houses the manual food preparation surface at a working height between 36 inches and 38 inches above a floor.

3. The modular system of claim 1, wherein the food preparation unit further comprises:
a first base platform:
configured to transiently locate within the dispenser receptacle; and
defining a first dispenser seat section configured to locate the first food dispensing assembly and the second food dispensing assembly within the dispenser receptacle, the first dispenser seat section comprising:
the first set of actuators configured to mechanically couple to a first set of drivetrains of the first food dispensing assembly and a second set of drivetrains of the second food dispensing assembly; and
a second base platform:
configured to transiently locate within the dispenser receptacle in replacement of the first base platform;
defining a second dispenser seat section configured to locate a third food dispensing assembly loaded with a third volume of a third ingredient type, within the dispenser receptacle and adjacent the manual food preparation surface, the third volume approximately one third of the first volume;
defining a third dispenser seat section configured to locate a fourth food dispensing assembly loaded with the third volume of a fourth ingredient type, within the dispenser receptacle and adjacent the third food dispensing assembly opposite the manual food preparation surface;
defining a fourth dispenser seat section configured to locate a fifth food dispensing assembly loaded with the third volume of a fifth ingredient type, within the dispenser receptacle and adjacent the fourth food dispensing assembly opposite the third food dispensing assembly; and
defining a second set of actuators adjacent the dispenser receptacle and configured to:
selectively actuate a third set of agitators in the third food dispensing assembly to dispense a third serving of the third ingredient type toward the autonomous assembly zone;
selectively actuate a fourth set of agitators in the fourth food dispensing assembly to dispense a fourth serving of the fourth ingredient type toward the autonomous assembly zone; and
selectively actuate a fifth set of agitators in the fifth food dispensing assembly to dispense a fifth serving of the fifth ingredient type toward the autonomous assembly zone.

4. The modular system of claim 3, wherein the first base platform defines the first dispenser seat section comprising:
the first actuator configured to mechanically couple with a first drivetrain of the first food dispensing assembly:
to rotate the first agitator in the first food dispensing assembly to drive the first ingredient type toward the first outlet of the first food dispensing assembly; and
the second actuator configured to mechanically couple with a second drivetrain of the first food dispensing assembly:
to open the first outlet to dispense the first serving of the first ingredient type toward the autonomous assembly zone.

5. The modular system of claim 3, wherein the second base platform defines:
the second dispenser seat section comprising:
a third actuator arranged on a first side of the dispenser receptacle and configured to mechanically couple to a third mount section of the third food dispensing assembly; and
a fourth actuator arranged on a second side of the dispenser receptacle opposite the first side and configured to mechanically couple to a fourth mount section of the third food dispensing assembly to locate the third food dispensing assembly within the second dispenser seat section;
the third dispenser seat section comprising:
a fifth actuator arranged on the first side of the dispenser receptacle and configured to mechanically couple to a fifth mount section of the fourth food dispensing assembly; and
a sixth actuator arranged on the second side of the dispenser receptacle and configured to mechanically couple to a sixth mount section of the fourth food dispensing assembly to locate the fourth food dispensing assembly within the third dispenser seat section; and
the fourth dispenser seat section comprising:
a seventh actuator arranged on the first side of the dispenser receptacle and configured to mechanically couple to a seventh mount section of the fifth food dispensing assembly; and
an eighth actuator arranged on the second side of the dispenser receptacle and configured to mechanically couple to an eighth mount section of the fifth food dispensing assembly to locate the fifth food dispensing assembly within the fourth dispenser seat section.

6. The modular system of claim 3:
wherein the first base platform comprises:
the first actuator configured to mechanically couple to a first drivetrain of the first food dispensing assembly to rotate the first agitator in the first food dispensing assembly to drive the first ingredient type toward the first outlet of the first food dispensing assembly; and
the second actuator configured to mechanically couple to a second drivetrain of the first food dispensing assembly to open the first outlet to dispense the first serving of the first ingredient type toward the autonomous assembly zone; and
wherein the second base platform comprises:
a gearbox configured to mechanically couple to a set of couplers configured to locate the third, fourth, and fifth food dispensing assemblies and coupled to a set of drivetrains of the third, fourth, and fifth food dispensing assemblies;
a third actuator configured to drive the gearbox to rotate the set of couplers to selectively trigger release of volumes of the third, fourth, and fifth ingredient types from the third, fourth, and fifth food dispensing assemblies toward the autonomous assembly zone; and
a fourth actuator configured to selectively couple the third actuator to one of the third, fourth, and fifth food dispensing assemblies via the gearbox.

7. The modular system of claim 1:
further comprising a controller configured to access a motor profile defining rotation of the first actuator and the second actuator in the first configuration; and
wherein the food preparation unit is configured to, in the first configuration:
actuate the first actuator at a first speed according to the motor profile to rotate the first agitator in the first food dispensing assembly to drive the first ingredient type toward the first outlet of the first food dispensing assembly; and
actuate the second actuator at a second speed, greater than the first speed, according to the motor profile to open the first outlet to dispense the first serving of the first ingredient type toward the autonomous assembly zone.

8. The modular system of claim 7:
wherein the food preparation unit:
further comprises a scanner configured to read a first dispenser identifier arranged on the first food dispensing assembly; and
is configured to retrieve the motor profile, defining rotation of the first actuator and the second actuator for the first configuration, associated with the first dispenser identifier.

9. The modular system of claim 1:
further comprising the first food dispensing assembly comprising:
an ingredient container:
configured to transiently store the first ingredient type within an interior volume of the ingredient container;
comprising a primary region configured for loading the first ingredient type;
comprising the first outlet fluidly coupled to the primary region;
comprising a first barrier interposed between the primary region and the first outlet and defining an upper edge arranged at a first height above a bottom surface of the ingredient container;
comprising a second barrier:
transiently installed above the first outlet;
defining a lower edge, proximal the primary region and arranged at a second height above the bottom surface of the ingredient container greater than the first height; and
configured to deflect ingredients away from the first outlet and towards the primary region; and
defining an opening interposed between the upper edge of the first barrier and the lower edge of the second barrier and configured to enable flow of the first ingredient type from the primary region into the first outlet; and
a dispenser subassembly coupled to a bottom of the ingredient container and configured to locate the first food dispensing assembly within the dispenser receptacle; and
wherein the food preparation unit is configured to, in the first configuration:
actuate the first actuator to rotate a first horizontal agitator extending across the primary region of the ingredient container to drive the first ingredient type stored in the primary region vertically upward and horizontally through the opening and over the first barrier toward the first outlet.

10. The modular system of claim 1, wherein the food preparation unit is configured to:
in the second configuration with the dispenser receptacle occupied by the second food dispensing assembly loaded with the first volume of the second ingredient type:
actuate the second actuator to rotate a first agitator cartridge comprising the second set of agitators of a second geometry to drive the second ingredient type toward the second outlet of the second food dispensing assembly and to open the second outlet to dispense the second serving of the second ingredient type toward the autonomous assembly zone; and
in a third configuration with the dispenser receptacle occupied by the second food dispensing assembly loaded with the first volume of a third ingredient type:
actuate the second actuator to rotate a second agitator cartridge comprising a third set of agitators of a third geometry to drive the third ingredient type toward the second outlet of the second food dispensing assembly and to open the second outlet to dispense a third serving of the third ingredient type toward the autonomous assembly zone.

11. The modular system of claim 1, further comprising a controller configured to:
receive a food order indicating the first ingredient type;
trigger the first conveyor unit to advance by a first distance to locate the food container in a first position aligned with the first outlet of the first food dispensing assembly;
trigger actuation of the first actuator to rotate the first agitator in the first food dispensing assembly to drive the first ingredient type toward the first outlet of the first food dispensing assembly; and
trigger actuation of the second actuator to open the first outlet to dispense the first serving of the first ingredient type into the food container.

12. The modular system of claim 11, further comprising a second food preparation unit, in the sequence of food preparation units, arranged adjacent the food preparation unit and comprising:
a second manual food preparation surface;
a second autonomous assembly zone arranged below the second manual food preparation surface;
a second dispenser receptacle arranged over the second autonomous assembly zone and adjacent the second manual food preparation surface;
a second conveyor unit arranged within the second autonomous assembly zone and configured to traverse the food container under the second dispenser receptacle and through the second autonomous assembly zone; and
a second set of actuators adjacent the second dispenser receptacle and configured to:
in the first configuration with the dispenser receptacle occupied by a third food dispensing assembly loaded with the first volume of a third ingredient type:
actuate a third actuator to rotate a third agitator in the third food dispensing assembly to drive the third ingredient type toward a third outlet of the third food dispensing assembly; and
actuate a fourth actuator to open the third outlet to dispense a third serving of the third ingredient type toward the second autonomous assembly zone.

13. The modular system of claim 12, wherein the controller is further configured to:
receive the food order indicating the first ingredient type and the third ingredient type;
trigger the first conveyor unit to advance by a second distance to transfer the food container from the autonomous assembly zone to the second autonomous assembly zone;
trigger the second conveyor unit to advance by a third distance to locate the food container in a second position aligned with the third outlet of the third food dispensing assembly;
trigger actuation of the third actuator to rotate the third agitator in the third food dispensing assembly to drive the third ingredient type toward the third outlet of the third food dispensing assembly; and
trigger actuation of the fourth actuator to open the third outlet to dispense the third serving of the third ingredient type into the food container.

14. A modular system comprising:
a kit of food dispensing assemblies comprising:
a first food dispensing assembly storing a first volume of a first ingredient type; and
a second set of food dispensing assemblies, each food dispensing assembly in the second set of food dispensing assemblies storing a second volume of an ingredient in a second set of ingredient types, the second volume approximately one third of the first volume; and
a food preparation unit configured to locate in a sequence of food preparation units and comprising:
a manual food preparation surface;
an autonomous assembly zone arranged below the manual food preparation surface;
a dispenser receptacle:
arranged over the autonomous assembly zone and adjacent the manual food preparation surface; and
configured to:
transiently receive the first food dispensing assembly in a first configuration; and
transiently receive the second set of food dispensing assemblies, in replacement of the first food dispensing assembly, in a second configuration;
a first conveyor unit arranged within the autonomous assembly zone and configured to traverse a food container under the dispenser receptacle and through the autonomous assembly zone; and
a first set of actuators adjacent the dispenser receptacle and configured to:
trigger release of volumes of the first ingredient type from the first food dispensing assembly toward the autonomous assembly zone in the first configuration; and
trigger release of volumes of the second set of ingredient types from the second set of food dispensing assemblies toward the autonomous assembly zone in the second configuration.

15. The modular system of claim 14:
wherein the first food dispensing assembly comprises:
an ingredient container:
configured to transiently store the first ingredient type within an interior volume of the ingredient container;
comprising an upper rim configured to seat approximately flush with the manual food preparation surface;
defining an upper opening defined by the upper rim and configured to expose the first ingredient type from the interior volume of the ingredient container toward the manual food preparation surface; and
comprising a first outlet configured to transiently release volumes of the first ingredient type from the interior volume of the ingredient container toward the autonomous assembly zone; and
wherein the food preparation unit:
defines a manual assembly zone encompassing the manual food preparation surface and the upper opening of the ingredient container;
defines the autonomous assembly zone:
below the manual assembly zone; and
housing autonomous preparation of food products; and
houses the manual food preparation surface at a working height range between 36 inches and 38 inches above a floor.

16. The modular system of claim 14, wherein the first set of actuators is configured to:
in the first configuration with the dispenser receptacle occupied by the first food dispensing assembly loaded with the first volume of the first ingredient type:
actuate a first actuator to rotate a first agitator in the first food dispensing assembly to drive the first ingredient type toward a first outlet of the first food dispensing assembly; and
actuate a second actuator to open the first outlet to dispense a first serving of the first ingredient type toward the autonomous assembly zone; and
in the second configuration with the dispenser receptacle occupied by a second food dispensing assembly in the second set of food dispensing assemblies loaded with the second volume of a second ingredient type in the second set of ingredient types:
actuate the first actuator to rotate a first set of agitators in the second food dispensing assembly to drive the second ingredient type toward a second set of agitators in the second food dispensing assembly; and
actuate the second actuator to rotate the second set of agitators to drive the second ingredient type toward a second outlet of the second food dispensing assembly and to open the second outlet to dispense a second serving of the second ingredient type toward the autonomous assembly zone.

17. The modular system of claim 16:
further comprising a controller configured to access a motor profile defining rotation of the first actuator and the second actuator in the first configuration; and
wherein the food preparation unit is configured to, in the first configuration:
actuate the first actuator at a first speed according to the motor profile to rotate the first agitator in the first food dispensing assembly to drive the first ingredient type toward the first outlet of the first food dispensing assembly; and
actuate the second actuator at a second speed, greater than the first speed, according to the motor profile to open the first outlet to dispense the first serving of the first ingredient type toward the autonomous assembly zone.

18. The modular system of claim 14:
wherein the kit of food dispensing assemblies further comprises:
a third set of food dispensing assemblies, each food dispensing assembly in the third set of food dispensing assemblies storing a third volume of an ingredient in a third set of ingredient types, the third volume approximately one sixth of the first volume; and
further comprising a second food preparation unit, in the sequence of food preparation units, arranged adjacent the food preparation unit and comprising:
a second manual food preparation surface;
a second autonomous assembly zone arranged below the second manual food preparation surface;
a second dispenser receptacle arranged over the second autonomous assembly zone and adjacent the second manual food preparation surface;
a second conveyor unit arranged within the second autonomous assembly zone and configured to traverse the food container under the second dispenser receptacle and through the second autonomous assembly zone; and
a second set of actuators adjacent the second dispenser receptacle and configured to:
trigger release of volumes of the second set of ingredient types from the second set of food dispensing assemblies toward the second autonomous assembly zone in the first configuration; and
trigger release of volumes of the third set of ingredient types from the third set of food dispensing assemblies toward the second autonomous assembly zone in the second configuration.

19. The modular system of claim 14, wherein the food preparation unit further comprises:
a first base platform:
configured to transiently locate within the dispenser receptacle in the first configuration; and
defining a first dispenser seat section configured to locate the first food dispensing assembly within the dispenser receptacle and adjacent the manual food preparation surface; and
a second base platform:
configured to transiently locate within the dispenser receptacle, in replacement of the first base platform, in the second configuration;
defining a second dispenser seat section configured to locate a second food dispensing assembly, in the second set of food dispensing assemblies loaded with the second volume of a second ingredient type, within the dispenser receptacle and adjacent the manual food preparation surface;
defining a third dispenser seat section configured to locate a third food dispensing assembly, in the second set of food dispensing assemblies loaded with the second volume of a third ingredient type, within the dispenser receptacle and adjacent the third food dispensing assembly opposite the manual food preparation surface; and
defining a fourth dispenser seat section configured to locate a fourth food dispensing assembly, in the second set of food dispensing assemblies loaded with the second volume of a fourth ingredient type, within the dispenser receptacle and adjacent the third food dispensing assembly opposite the second food dispensing assembly.

20. A food preparation unit comprising:
a manual food preparation surface;
an autonomous assembly zone arranged below the manual food preparation surface;
a dispenser receptacle arranged over the autonomous assembly zone and adjacent the manual food preparation surface;
a conveyor unit arranged within the autonomous assembly zone and configured to traverse a food container under the dispenser receptacle and through the autonomous assembly zone; and
a set of actuators adjacent the dispenser receptacle and configured to:
in a first configuration with the dispenser receptacle occupied by a first food dispensing assembly loaded with a first ingredient type:
selectively actuate to rotate a first set of agitators in the first food dispensing assembly to drive the first ingredient type toward a first outlet of the first food dispensing assembly and to open the first outlet to dispense a first serving of the first ingredient type toward the autonomous assembly zone; and
in a second configuration with the dispenser receptacle occupied by a second food dispensing assembly loaded with a second ingredient type:
selectively actuate to rotate a second set of agitators in the second food dispensing assembly to drive the second ingredient type toward a second outlet of the second food dispensing assembly and to open the second outlet to dispense a second serving of the second ingredient type toward the autonomous assembly zone.
